(19) United States
(12) Patent Application Publication
(10) Pub. No.: US 2025/0247504 A1
(43) Pub. Date: Jul. 31, 2025

(54) SIGNAL TRANSPORT WITHIN VEHICLES

(71) Applicant: HYPHY USA Inc., San Jose, CA (US)

(72) Inventors: Timothy J. VEHLING, San Jose, CA (US); Alex HENZEN, NM Bladel (NL)

(21) Appl. No.: 19/033,963

(22) Filed: Jan. 22, 2025

Related U.S. Application Data
(60) Provisional application No. 63/625,473, filed on Jan. 26, 2024.

(51) Int. Cl. H04N 7/18; B60R 1/22; B60W 50/14; H04N 5/38; H04N 7/04

(52) U.S. Cl. CPC H04N 7/183; H04N 5/38; H04N 7/04; B60R 1/22; B60W 50/14; B60W 2050/146; B60W 2420/403

(57) ABSTRACT

Signal transport within vehicles uses analog levels (encoded or not) to transport signals. Sampled-analog video transport (SAVT) is used to transport video data, LiDAR data, radar data, or ultrasonic data between cameras, processors and displays within a vehicle. The technology transmits signals as analog levels rather than as digital signals. Or, spread-spectrum video transport (SSVT) is used to transport video data, LiDAR data, radar data, or ultrasonic data between cameras, processors and displays within a vehicle. The technology transmits signals as encoded analog levels rather than as digital signals making transmission simpler and providing higher bandwidth. The encoding provides more signal resilience and protection against interfering noise, EMF, etc. The received signals are displayed or direct an actuator.

This application claims priority of U.S. provisional patent application No. 63/625,473 filed Jan. 26, 2024 entitled “Signal Transport Within Vehicles,” which is hereby incorporated by reference.

This application incorporates by reference U.S. patent application Ser. No. 18/442,491 (Docket No. HYFYP0015), filed Feb. 15, 2024, entitled “ANALOG VIDEO TRANSPORT TO A DISPLAY PANEL AND SOURCE DRIVER INTEGRATION WITH A DISPLAY PANEL” as well as U.S. patent application Ser. No. 18/821,542, filed on Aug. 30, 2024 and Ser. No. 18/921,989, filed on Oct. 21, 2024 (Docket Nos. HYFYP0015X1 and HYFYP0015X1X1).

This application incorporates by reference U.S. application Ser. No. 15/925,123, filed on Mar. 19, 2018 (Docket No. HYFYP001), now U.S. Pat. No. 10,158,396, issued Dec. 18, 2018, U.S. application Ser. No. 16/494,901 filed on Sep. 17, 2019 (Docket No. HYFYP002), U.S. application Ser. No. 17/879,499 filed on Aug. 2, 2022 (Docket No. HYFYP003), U.S. application Ser. No. 17/686,790, filed on Mar. 4, 2022 (Docket No. HYFYP004AX1), U.S. application Ser. No. 17/887,849 filed on Aug. 15, 2022 (Docket No. HYFYP006), U.S. application Ser. No. 17/851,821, filed Jun. 28, 2022 (Docket No. HYFYP007), U.S. application Ser. No. 18/448,330, filed Aug. 11, 2023 (Docket No. HYFYP008), U.S. patent application Ser. No. 17/900,570 (HYFYP009), filed Aug. 31, 2022, U.S. application Ser. No. 17/946,479 filed on Sep. 16, 2022 (Docket No. HYFYP010), U.S. application Ser. No. 18/095,801 filed on Jan. 11, 2023, (Docket No. HYFYP011), U.S. patent application Ser. No. 18/098,612 (HYFYP013), filed Jan. 18, 2023, U.S. application Ser. No. 18/117,288 filed on Mar. 3, 2023 (Docket No. HYFYP014), and U.S. application Ser. No. 18/442,447 filed on Feb. 15, 2024 (Docket No. HYFYP017).

### FIELD OF THE INVENTION

The present invention relates generally to local site transport of signals within a vehicle. More specifically, the present invention relates to transmitting or receiving electromagnetic signals based upon external cameras or other sensors.

### BACKGROUND OF THE INVENTION

As autonomous or self-driving vehicles become more common they also become more complex as not only the types of signals transported within a vehicle increase, but also the sheer amount of data that must be transported for each signal type increases. Currently, such vehicles rely upon video cameras, LiDAR sensors, radar sensors, ultrasonic sensors, etc., for their self-driving functions, as well as for routine maneuvers such as backing up, parking, etc.

For certain of these sensors (especially LiDAR), the amount of data that must be transported from the sensor itself to a processor is staggering, and the distances involved for transport are far greater than typical distances traveled by video (for example) within a mobile device or a large panel display. Signal degradation can occur for a number of reasons including distance traveled, interference from other vehicular signals, and outside interference as the vehicle travels through any number of external radio-frequency networks. In addition, latency can be a problem for certain signal types. Accordingly, improvements are needed for signal transport within vehicles.

### SUMMARY OF THE INVENTION

To achieve the foregoing, and in accordance with the purpose of the present invention, various techniques and apparatus are disclosed that improve signal transport within vehicles.

In one embodiment, sampled-analog video transport (SAVT) is used to transport video data, LiDAR data, radar data, or ultrasonic data between cameras, processors and displays within a vehicle. The technology transmits signals as analog levels rather than as digital signals making transmission simpler and providing higher bandwidth.

In a second embodiment, spread-spectrum video transport (SSVT) is used to transport video data, LiDAR data, radar data, or ultrasonic data between cameras, processors and displays within a vehicle. The technology transmits signals as encoded analog levels rather than as digital signals making transmission simpler and providing higher bandwidth. The encoding provides more signal resilience and protection against interfering noise, EMF, etc.

Using an SAVT signal or an SSVT signal to transport video samples, LiDAR data, radar data or ultrasonic data in a vehicle has numerous advantages. Historic video transport was baseband, and was extremely noise sensitive. Implementation of digital video brought a virtually noise-free transition, but at the expense of much higher bandwidth. With more and more video and other signals such as LiDAR, radar and ultrasonic being transmitted digitally in vehicles, the industry is running out of bandwidth, and the use of analog signals such as SSVT or SAVT solves this problem.

### BRIEF DESCRIPTION OF THE DRAWINGS

The invention, together with further advantages thereof, may best be understood by reference to the following description taken in conjunction with the accompanying drawings in which:

FIG. 1 illustrates a vehicle such as an automobile that includes a variety of cameras, sensors and processors.

FIG. 2 illustrates video transport from a camera of a vehicle to an ADAS or IVI processor.

FIG. 3 illustrates the SSVT transmitter of FIG. 2.

FIG. 4 illustrates the SSVT receiver of FIG. 2 which may be implemented at ADAS processor, at IVI processor or at a display of the vehicle.

FIG. 5 illustrates a first embodiment in which video data is transported to a legacy display panel and a second embodiment in which video data is transported to a novel display panel in which an SSVT receiver is integrated with source drivers.

FIG. 6 illustrates in greater detail an SSVT receiver integrated with source drivers of a display panel.

FIG. 7 illustrates a spread-spectrum data transport (SSDT) transmitter at a LiDAR sensor.

FIG. 8 illustrates an SSDT receiver at an ADAS processor of a vehicle.

FIG. 9 illustrates an SSDT transmitter at a radar sensor.

FIG. 10 illustrates an SSDT receiver at an ADAS processor of a vehicle.

FIG. 11 illustrates an SSDT transmitter at an ultrasonic sensor.

FIG. 12 illustrates an SSDT receiver at an ADAS processor of a vehicle.

FIG. 13 illustrates video transport from a camera of a vehicle to an ADAS or IVI processor.

FIG. 14 illustrates an architecture of an SAVT transmitter at a video source.

FIG. 15 illustrates an SAVT receiver.

FIG. 16 illustrates a first embodiment in which video data is transported to a legacy display panel and a second embodiment in which video data is transported to a novel display panel in which an SAVT receiver is integrated with each source driver.

FIG. 17 illustrates in greater detail an SAVT receiver integrated with a source driver of a display panel, each of the other receivers, etc. being implemented in a similar manner and driving its respective columns.

FIG. 18 illustrates a source driver input of a source driver for interleaving multiple input amplifiers which allows speed requirements to be met.

FIG. 19 is a summary of a pixel transmission order showing how pixels and control signals are transmitted from the SAVT transmitter to the source driver and to which amplifier each is assigned.

FIG. 20 is a block diagram of an input vector of an SAVT transmitter having a predetermined permutation that provides for the sequence of sub-pixel transmission required by FIG. 19.

FIG. 21 illustrates a sampled-analog data transport (SADT) transmitter at a LiDAR sensor.

FIG. 22 illustrates an SADT receiver at an ADAS processor of a vehicle.

FIG. 23 illustrates an SADT transmitter at a radar sensor.

FIG. 24 illustrates an SADT receiver at an ADAS processor of a vehicle.

FIG. 25 illustrates an SADT transmitter at an ultrasonic sensor.

FIG. 26 illustrates an SADT receiver at an ADAS processor of a vehicle.

FIG. 27 illustrates an example showing how signal samples, in this case, analog values, are encoded within an encoder and then sent over an electromagnetic pathway.

FIG. 28 illustrates a novel encoding technique as being applicable to signal samples that are digital values.

FIG. 29 illustrates decoding of analog input levels that were encoded using the analog encoder above.

FIG. 30A illustrates use of an analog encoder and a corresponding analog decoder.

FIG. 30B illustrates use of a digital encoder and a corresponding analog decoder

FIG. 30C illustrates use of a digital decoder to decode encoded analog signals that have arrived over an electromagnetic pathway.

FIG. 31 shows a simulation of an SSVT waveform sent via an electromagnetic pathway.

FIG. 32 shows a combined video or data transport embodiment.

FIGS. 33A and 33B illustrate a computer system suitable for implementing embodiments of the present invention.

### DETAILED DESCRIPTION OF THE INVENTION

Currently, a variety of technologies are used for transporting video and other signals within a vehicle (such as an automobile) between a camera or a sensor and a processing unit, and between a processing unit and a display. Embodiments of the present invention replace an existing video transport technology between a camera (or any other sensor) and a processing unit or between a processing unit and a display with either a spread-spectrum video transport (SSVT) technology or a sampled-analog video transport (SAVT) technology. Other embodiments of the present invention replace an existing signal transport technology (e.g., for transport of LiDAR, radar or ultrasonic data) between a sensor and a processing unit with either spread-spectrum data transport (SSDT) technology or sampled-analog data transport (SADT) technology. The SAVT technology may also be referred to as “clocked-analog video transport” or CAVT, and the SADT technology may also be referred to as “clocked-analog data transport” or CADT. Further, these embodiments may replace or co-exist with existing signal transport technology.

It is realized that noise is a much larger concern in automotive applications because of hostile and uncorrelated signals nearby, and that the electrical environment is quite harsh. Additionally, moving a discrete-time, discrete-amplitude analog signal across meters means channel impairments are also more notable; the frequency is lower but for longer distances this means path losses and resonances from the much longer connections are now more apparent versus a display application. As many automotive cables can be up to 15 meters, it is expected that many applications using the technology described herein may elect SSVT (or SSDT) due to its spread-spectrum feature.

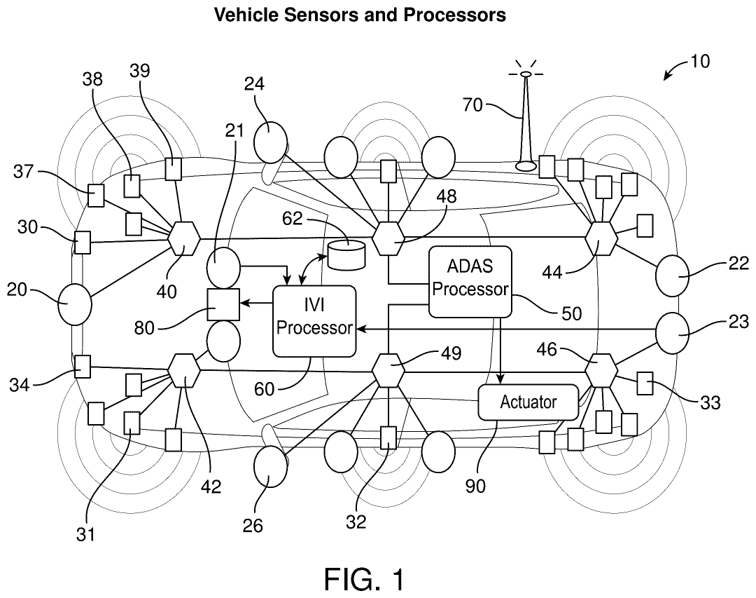

FIG. 1 illustrates a vehicle 10 such as an automobile that includes a variety of cameras, sensors and processors. Vehicle 10 may be any moving vehicle on which it is advantageous to include video cameras and sensors for the purposes of driving the vehicle, controlling the vehicle, assisting the driver, avoiding collisions, providing for safety, parking the vehicle, monitoring the surroundings of the vehicle while stationary or parked, self driving, autonomous driving, or similar functions, as well as for providing information and entertainment on displays within the vehicle, capturing or storing video information from cameras mounted on the vehicle, etc. Vehicle 10 may be any vehicle such as an automobile, truck, tractor trailer, trailer, bus, streetcar, car of a light-rail or a heavy-rail train, boat, military vehicles such as a tank or armored personnel carrier, motorcycle, or even vehicles in the air or in space such as airplanes, drones, balloons, spacecraft and satellites.

As shown, the vehicle includes a front-facing camera 20, rear cameras 22 and 23, side-mounted cameras 24 and 26 as well as cameras in other positions. Sensors are shown in square boxes and include a front-mounted sensor 30, a corner-mounted sensor 31, a side-mounted sensor 32, a rear-mounted sensor 33, as well as sensors in other positions as shown. Typically, a variety of sensors are used including radar, LIDAR, and ultrasonic.

Any of the cameras may transmit image or video data to an IVI (in-vehicle information/entertainment) system that includes processor 60 which then processes and transmits the image or video data to display 80 at the dashboard of the vehicle for viewing by the driver or front passenger. By way of example, front-facing camera 21 and rear-facing camera 23 both transmit video data to the IVI processor 60. These cameras 21 and 23 are referred to as “convenience” cameras in that their video data is for the driver's convenience (i.e., a backup camera, a front-facing camera for recording the journey, etc.) and is sent to IVI processor 60, as opposed to “safety” cameras whose video data is sent to ADAS processor 50 for use in controlling the vehicle (e.g., cameras 20 and 22). It is also possible that a particular camera feeds both processor 50 and processor 60.

Of course, displays located in other parts of the vehicle may also receive video data from IVI processor 60. Further, camera 21 may be an in-cabin camera for monitoring the driver or passenger. Processor 60 may also communicate with persistent storage device 62 in order to store video data or to retrieve video data. Antenna 70 receives data wirelessly and may transmit that data over a wired connection (not shown) to IVI processor 60 for display upon display 80; video or sensor data generated within the vehicle may also be transmitted from either processor 50 or 60 to antenna 70 for transmission.

Also included within the vehicle 10 is an ADAS (advanced driver assistance system) that includes an ADAS processor 50 which inputs camera and sensor information and drives actuators to control the vehicle. As shown, vehicle 10 includes any number (i.e., zero or more) of intermediate processing units 40-49 that eventually connect all safety cameras and sensors of the vehicle to ADAS processor 50. These intermediate processing units may be used to aggregate data from a particular type of sensor (e.g., aggregation of all data from LIDAR sensors), to aggregate data from different sensors in a particular area of the vehicle (e.g., aggregate data from sensors 37-39 in the right-front corner of the vehicle no matter the type of camera or sensor), or for other reasons. It is also possible that vehicle 10 does not include any intermediate processors and that all data from the safety cameras and the various sensors are sent directly to ADAS processor 50.

ADAS processor 50 receives data from the safety cameras and the sensors, processes that data, makes decisions, and depending upon the driving mode, driver preference, and safety, may choose to operate various actuators in order to control the vehicle. By way of example, processor 50 may direct a brake system actuator (such as actuator 90) to brake the vehicle, may direct a steering actuator (not shown) to steer the vehicle, may direct an accelerator actuator (not shown) to accelerate or decelerate the vehicle, or may direct other actuators present in the vehicle such as actuators for doors, windows, trunk, lights, wipers, etc. Processor 50 may also be referred to as an ECU (electronic control unit) and there may be a single such processor 50 within the vehicle or there may be numerous distributed processors receiving data from different sensors and making decisions for particular actuators.

As mentioned, numerous technologies are currently used to transport video data within an automobile from a camera to a processor and from the processor to a display. For instance, GMSL3 from Analog Devices, Inc., FPD-Link IV from Texas Instruments, Auto E-Net from Marvel, and MIPI A-PHY from Valens may all be used to transport video data with an automobile. Embodiments of the present invention replace any of these technologies with either SSVT or SAVT.

### Spread-Spectrum Video Transport Between Camera and Processor

As mentioned above, one embodiment of the present invention uses spread-spectrum video transport (SSVT) to transport video data from a camera of the vehicle to a processor such as an IVI processor or an ADAS processor. It is believed that SSVT is preferable for in-vehicle applications to transport video for the reasons given above. For one, transport distances are longer. SSVT video samples are not digitized before transmitting but are sent as encoded analog signals to the receiver. The encoding takes place to ensure largely error-free reception but leaves the video samples unchanged upon decoding (at most somewhat attenuated or amplified).

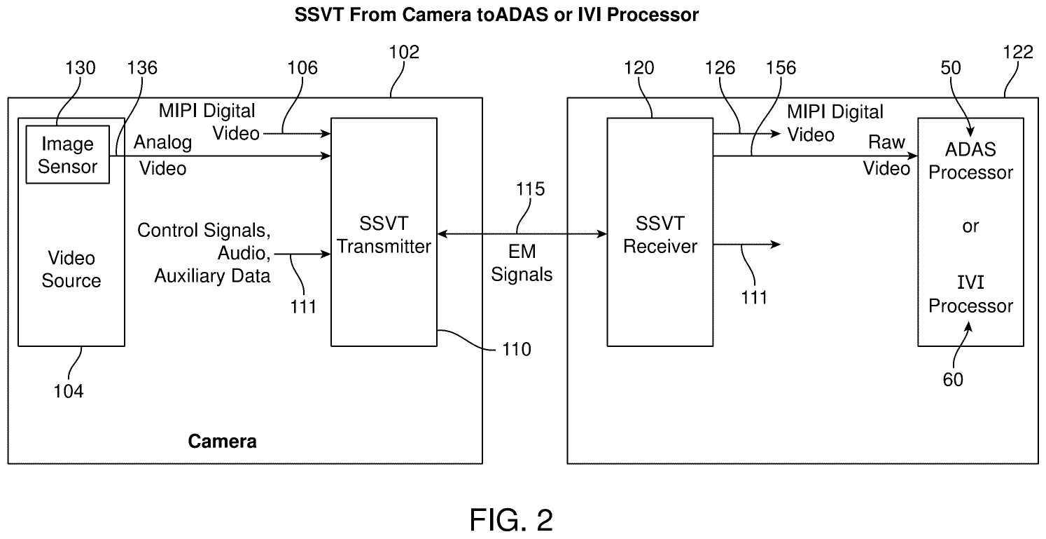

FIG. 2 illustrates video transport from a camera of a vehicle to an ADAS or IVI processor. As shown, video source 104 (such as any camera on the vehicle of FIG. 1) outputs digital video data 106 using a standard such as MIPI CSI via a suitable interface to an SSVT transmitter 110. The transmitter outputs any number of electromagnetic (EM) signals 115 to a corresponding SSVT receiver 120 located at an ADAS processor 50 or at an IVI processor 60 and outputs digital video data 126 using the same MIPI standard via a suitable interface. Transmitter 110 may be located upon the same circuit board as a video source, located in close proximity to the video source, located within a camera module of camera 102, or may be located external to the camera, etc. The receiver 120 may be integrated within the processor, located on the same circuit board as the processor, within the same module, or in close proximity to the processor.

As known in the art, the MIPI digital video data 106 is raw data from the image sensor 130, i.e., it is the raw pixel data after conversion to digital, but before color interpolation (e.g., a row of samples BGBG . . . followed by a row samples RGRG . . . ). EM signals 115 may be any number of signals, each over a suitable electromagnetic pathway, such as a twisted wire pair (shielded or unshielded), cable, wireless, or fiber optic. In one particular embodiment, a single EM signal 115 is transmitted over a single unshielded twisted wire pair (UTP).

SSVT replaces transport via GMSL, i.e., SSVT transmitter 110 replaces a GMSL serializer and SSVT receiver 120 replaces a GMSL deserializer. In addition to replacing GMSL3 transport as shown, the SSVT transmitter and receiver may also replace FPD-Link IV, Auto E-Net, and MIPI A-PHY transport between camera and the ADAS or IVI processor. SSVT transmitter 110 may be an integrated circuit that replaces an existing chip (e.g., a GMSL3 serializer chip) and SSVT receiver 120 may likewise replace an existing chip.

Further, an interface other than MIPI may be used to output video data from the video source, such as DSI, HDMI, DP, OLDI, par, and these other interfaces may output video data in formats such as those described herein including raw digital or analog video data or interpolated RGGB data.

In an alternative embodiment, instead of raw digital video signals being delivered to the transmitter 110 via a MIPI interface (or other interface), SSVT transmitter 110 is integrated with the video source and image sensor and receives the raw analog video data directly from image sensor 130 as a series of analog video samples 136. In other words, as the rows of analog video samples are read out from the image sensor (e.g., a row of samples BGBG . . . followed by a row samples RGRG . . . ) these analog video samples 136 are directly input into SSVT transmitter 110, thereby eliminating any ADCs within the video source as well as eliminating the MIPI interface and the need to convert the digital samples at the SSVT transmitter into analog. Once received at receiver 120, these raw analog video samples 136 may be output as raw video samples 156 (digital or analog) into processor 50 or processor 60.

In addition to sending a payload of video samples, any number and type of control signals or other data 111 may be input into SSVT transmitter 110 for transmission to the receiver for use at ADAS or IVI processor at a display. These other signals and data may be input into the transmitter as if they were video samples and are distributed, encoded and transmitted as if they were video samples. Since the SSVT receiver will know apriori which these control signals and data are, and where they will be inserted into the vectors of the transmitter (i.e., the specific permutation that the transmitter uses), the receiver is able to extract these control signals and data. If the video is digital then these other signals are digital as well, if the video is analog, then these other signals are analog as well. These other signals and auxiliary data may include: audio, Ethernet, control signals (such as GPIO, I2C, UART), video-specific control (e.g., frame synchronization), and clock signals.

SSVT receiver 120 may include a clock recovery circuit, a synchronization and acquisition circuit, or similar, in order to recover a reference clock and other timing signals at the receiver 120. There may be a single such circuit in receiver 120, or each decoder 230 may have such a circuit. The reference clock may be sent inherently in EM signals 115 (i.e., in the timing of the levels being sent), as a sub-band of samples, or in similar manners. Thus, the reference clock is sent using EM signals 115 and a separate line for a reference clock between transmitter and receiver is not needed. Alternatively, a separate global reference clock (with embedded other data) between transmitter and receiver may also be used.

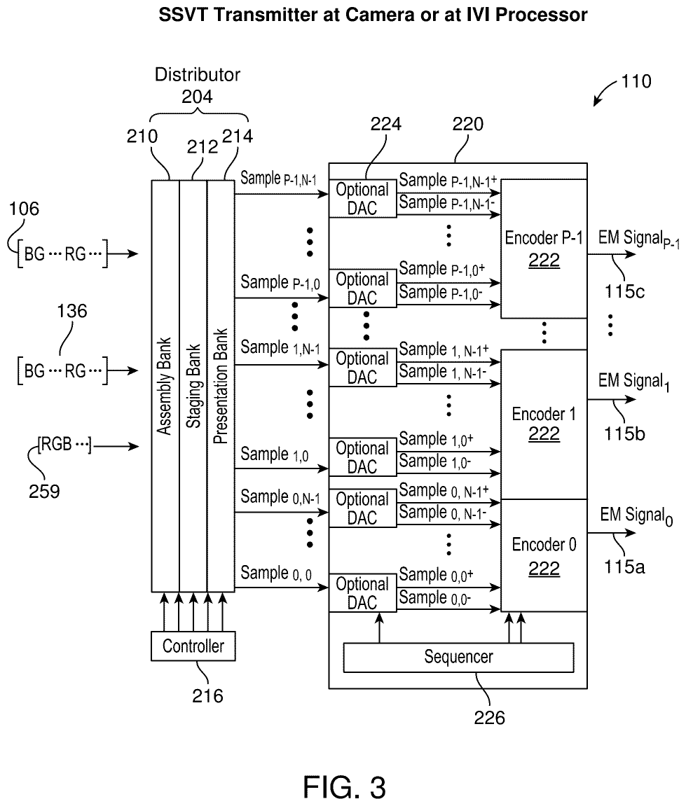

FIG. 3 illustrates the SSVT transmitter of FIG. 2. As explained earlier, input are either the digital BG . . . RG . . . samples 106 (one color sample per pixel of the image sensor) or the analog BG . . . RG . . . samples 136 read out directly from the image sensor. In the case of digital samples 106, DACs 224 are used and the encoding is analog, thus outputting analog EM signals. Alternatively, DACs 224 are not used, the encoding is digital, and the output from each encoder is passed through a DAC (not shown) before being output as an analog EM signal. In the case of analog samples 136 DACs 224 are not used and the encoding is analog, thus outputting analog EM signals.

Transmitter 110 is a logic block diagram of a specific implementation of an SSVT transmitter at a camera or IVI processor. The transmitter may be implemented within the camera itself, within the video source, or located in close proximity to the video source. The distributor 204 includes an assembly bank 210, a staging bank 212, a presentation bank 214 and a controller 216. An encoder block 220 includes a bank of optional digital-to-analog converters (DACs) 224 and encoders 222, one for each EM pathway of a transmission medium. As mentioned herein, a stream of samples from a single source (such as a camera, image sensor, another sensor, processor, etc.) arrives at transmitter 110 for encoding. As shown, the stream of video samples may arrive in parallel, serially, may arrive in any suitable grouping as shown at 106 or 136, and may represent any desirable color space. Each encoder 222 encodes one input vector and produces a series of output levels as an EM Signal. Accordingly, there may be any number (P) of encoders, one encoder per EM pathway.

The distributor 204 is arranged to receive the exposed color information (e.g., BGBG . . . RGRG . . . ) from the stream of sets of samples, one after the other. In response, the assembly bank 210 builds (in this example) three input vectors V₀, V₁, and V₂ from the exposed color information from the incoming stream of sets of samples. As the sets of samples are received, they are stored in the assembly bank 210 according to a predetermined permutation. Distributor 204 may use any number of different permutations when building the vectors containing N samples each and using distributor 204 we can reorder the samples as needed.

The staging bank 212 facilitates the crossing of the N samples of each of the three vectors V₀, V₁, and V₂ from a first clock frequency (or first timing domain) into a second clock frequency (or second domain) used for the encoding and transmission of the resulting EM signals over the transmission medium.

In various embodiments, the first clock frequency can be faster, slower or the same as the second clock frequency. The first clock frequency f_pix is determined by the video format selected by a video source. The second clock frequency f_ssvt is a function of f_pix, the number P of EM pathways in the transmission medium, the number S of samples in each set of input/output samples, and the SSVT transform parameters N (the number of input/output vector locations) and L (the length of each SSDS code), where f_ssvt=(f_pix*S*L)/(P*N). With this arrangement, the input clock (pix_clk) oscillates at one rate, and the SSVT clock (ssvt_clk) oscillates at another rate. These rates can be the same or different. The encoder performs the encoding while the next input vector is prepared. The presentation bank 214 presents the N samples of each of the three encoder input vectors V₀, V₁, and V₂ to the encoder block 220 (e.g., vector V₀ includes Sample_{0,0} through Sample_{0,N-1})

Controller 216 controls the operation and timing of assembly bank 210, the staging bank 212, and the presentation bank 214. In particular, the controller is responsible for defining the permutation used and the number of samples N when building the three encoder input vectors. The controller 216 is also responsible for coordinating the clock domain crossing from the first clock frequency to the second clock frequency as performed by the staging bank 212. The controller 216 is further responsible for coordinating the timing of when the presentation bank 214 presents the N samples of each of the three encoder input vectors to the encoder block 220.

Within the encoder block 220, any number of optional digital-to-analog converters (DACs) 224 are provided, each arranged to receive one of the P*N samples (Sample_{0,0} through Sample_{P-1,N-1}) assigned to the three encoder input vectors collectively. Each DAC 224 converts its received sample from the digital domain into a differential pair of voltage signals having a magnitude that is proportional to its incoming digital value. The output of the DACs 224 may range from a maximum voltage to a minimum voltage.

The three encoders 222 are provided for the three encoder input vectors respectively. Each encoder 222 receives the differential pair of signals for each of the N samples for its encoder input vector, modulates each of the N differential pair of voltage signals using chips from a code corresponding to each sample, accumulates the modulated values and then generates a differential EM signal output. Since there are three encoders 222 in this example, there are three EM signals 115a, 115b and 115c (Signal₀ through Signal₂) that are simultaneously transmitted over the transmission medium.

A sequencer circuit 226 coordinates the timing of the operation of the DACs 224 and the encoders 222 and is also responsible for controlling the clocking of the DACs 224 and the encoders 222. The sequencer circuit 226 generates two clock phase signals, “clk 1” and “clk 2”, that are responsible for controlling the operation of the encoders 222.

A receiver corresponding to transmitter 110 may be used to receive the output levels, decode, and collect the samples into the BGBG . . . RGRG . . . signals that were input (for example), as will be appreciated by one of skill in the art upon a reading of this disclosure. Analog encoding or digital encoding (and analog or digital decoding) may be used. DACs or ADCs may precede or follow the encoders (or decoders) as the case may be and as required by an implementation. For example, as each EM signal is a series of analog levels, if digital encoding is used then a DAC follows each encoder. Encoding and decoding may be performed as described in any of the applications and patents incorporated by reference above.

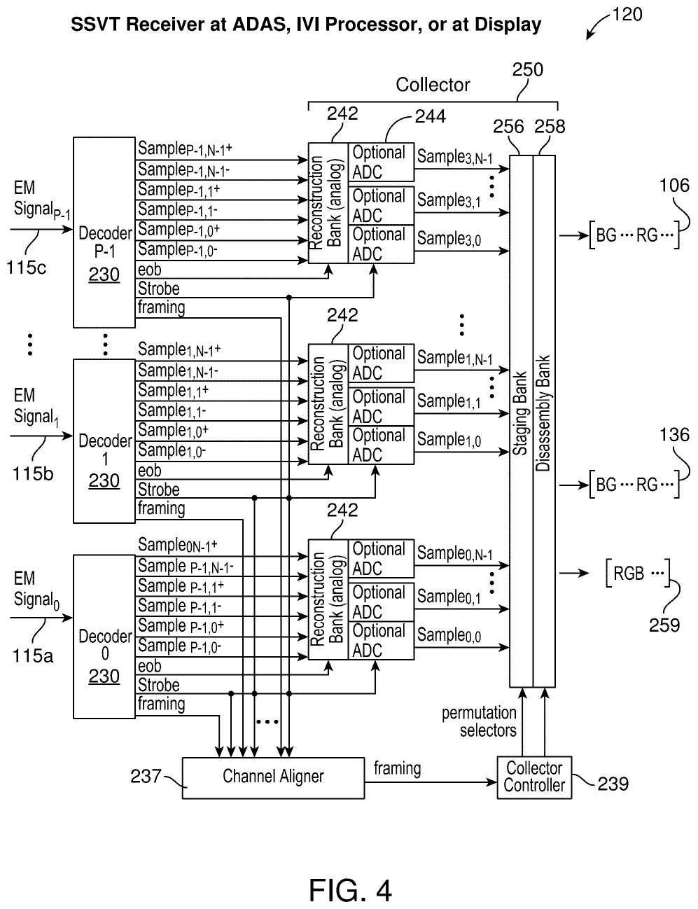

FIG. 4 illustrates the SSVT receiver of FIG. 2 which may be implemented at ADAS processor 50, at IVI processor 60 or at a display of the vehicle. As the decoded samples are analog, optional ADCs 244 may be used to convert the samples to digital before output. Or, ADCs 244 are not used and the output 106 is fed into an ADC or ADCs. Thus, output are the digital BG . . . RG . . . samples 106 (which may be input into the processor as MIPI digital video 126 using a suitable interface). If analog samples 136 are transported (e.g., BG . . . RG . . . samples 136 which had been read out directly from the image sensor), then ADCs 244 are used and the raw video 156 input to the processor is digital samples, or ADCs 244 are not used and the raw video 156 input to the processor is analog samples.

SSVT receiver 120 is a block diagram of an SSVT receiver 132 located at the ADAS, IVI processor or display. On the receive side, SSVT receiver 120 is responsible for decoding the stream of differential EM signals received over each electromagnetic pathway back into the stream of video samples originally presented to the corresponding SSVT transmitter. After processing within the ADAS, etc., the video content contained in the samples can be analyzed in order to drive actuators, can be processed, or can be delivered to and presented on video display 80, frame after frame. As a result, the video capture by the video source is re-created by the video sink. Alternatively, the decoded video information can be stored in storage 62 for display at a later time.

Receiver 120 performs the inverse of the encoding performed by the SSVT transmitter 110 on the transmit side. Receiver 120 uses any number of decoders 230 and a collector 250. The decoders 230 reconstruct the differential EM level signals into three decoder output vectors (in this example). The collector 250 then assigns the samples of the decoder output vectors to the original stream of sets of samples.

The P decoders 230 (labeled 0 through P−1) are arranged to receive differential EM Signal0 through SignalP−1 respectively. In response, each of the decoders 230 generates N differential pairs of reconstructed samples (Sample0 through SampleN−1). In the case where there are three decoders 230 (P=3), three output vectors V0, V1, and V2 are constructed respectively.

Reconstruction banks 242 sample and hold each of the differential pairs of N reconstructed samples (Sample0 through SampleN−1) for each of the three decoder output vectors at the end of each decoding interval respectively. An optional analog-to-digital converter (ADC) 244 is provided for each of the N samples (Sample0 through SampleN−1) for each of the three vectors respectively. Each ADC converts its received differential pair of voltage signals into a corresponding digital value, resulting in digital samples (SampleN−1 through Sample0) for each of the three vectors respectively. The ADCs operate at a clock rate=f_ssvt/L. Alternatively, each EM signal is input to an ADC before each decoder and the decoding is digital, in which case ADCs 244 are not required.

The collector 250 includes a staging bank 256 and a disassembly bank 258. The staging bank 256 receives the reconstructed samples for each of the three decoder output vectors. The disassembly bank 258 (a) disassembles the samples (SampleN−1 through Sample0) for each of the three decoder output vectors back into the exposed color information (e.g., the S signals) for the stream of sets of samples (e.g., in one example, S=3 for RGB pixels) using the same permutation scheme as used on the transmit side and (b) crosses the reconstructed samples from the second clock domain back to the first clock domain. The output samples shown at 106 and 136 correspond to the samples that were input into the transmitter at the camera.

Receiver 120 also includes a channel aligner 237 and a collector controller 239, which receives framing information and aperture information from each decoder 230. The framing signal signifies the timing for constructing video frames on the display panel.

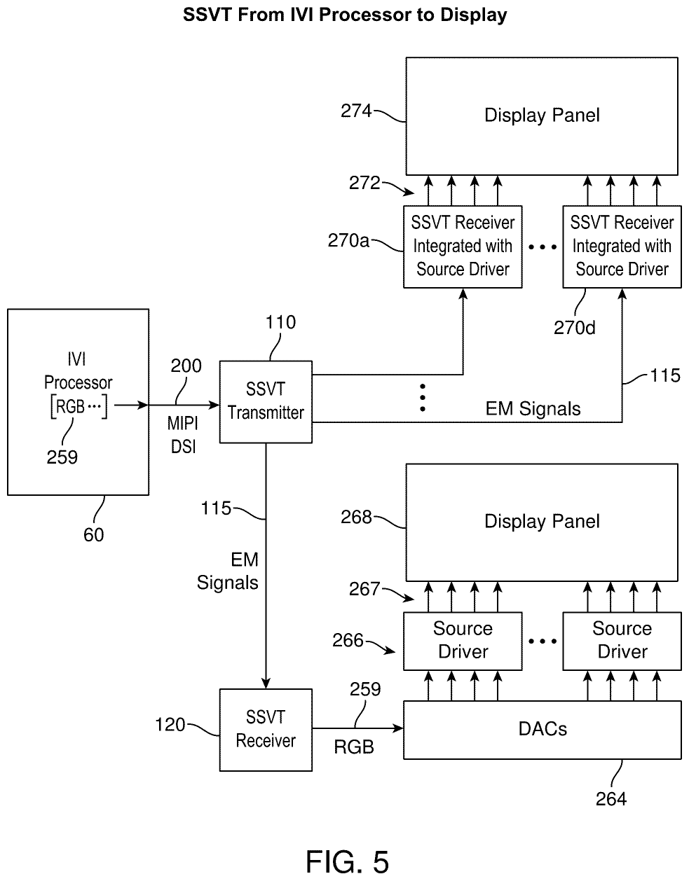

In response, the collector controller 239 coordinates the timing of the staging bank 256 and the disassembly bank 258 to ensure that all the samples presented to the disassembly bank come from a common time interval in which the level signals were sent by the SSVT transmitter 110. As a result, (a) the disassembly by the bank 258 may be delayed until all samples are received and (b) the individual channels of the transmission medium do not necessarily have to all be the same length since the disassembly bank 258 compensates for any timing differences. The collector controller 239 is also responsible for keeping track of any permutations and making sure that disassembly bank 258 applies the same permutation that was used in constructing the input vectors on the transmit side. If desirable, a retimer may be added for the RGB outputs 259 before they are input into the DACs of the display panel of FIG. 5 (useful for putting video signals into the correct order for processing), but this retiming may also be done at the transmitter rather than at the receiver.

### Spread-Spectrum Video Transport Between Processor and Display

As mentioned above, one embodiment of the present invention uses spread-spectrum video transport (SSVT) to transport video data from a processor such as an IVI processor to a display in the vehicle.

FIG. 5 illustrates a first embodiment in which video data is transported to a legacy display panel 268 and a second embodiment in which video data is transported to a novel display panel 274 in which an SSVT receiver is integrated with source drivers. An IVI processor 60 sends video data (e.g., digital RGB signals 259) over an MIPI DSI interface 260 (or over any other suitable interface) to SSVT transmitter 110 which in a first embodiment transports the video data over any number of EM signals 115 to SSVT receiver 120. SSVT receiver 120 outputs RGB signals 259 to source drivers 266, received at DACs 264 (which are part of the source drivers 266, and one of the last stages before driving the columns, although shown separately for clarity), and is known in the art, the source drivers use DACs 264 to convert the signals into analog which drive individual columns 267 of display panel 268.

In a second embodiment, SSVT transmitter 110 transmits the video data over any number of EM signals 115 each to an SSVT receiver integrated within source drivers 270a . . . 270d as will be explained in greater detail below. Each source driver 270a . . . 270d then drives individual columns 272 of display panel 274.

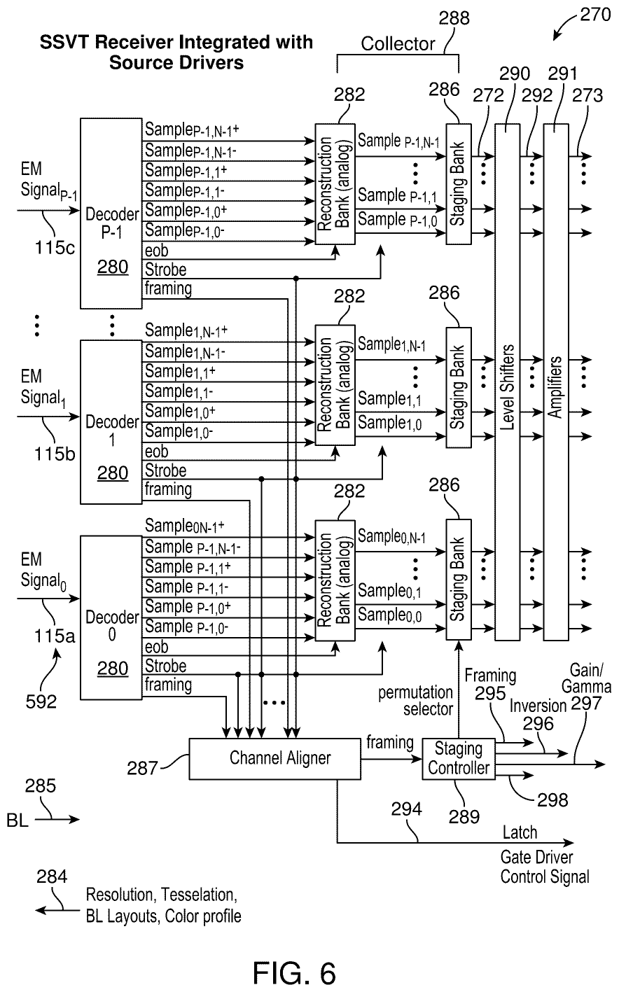

FIG. 6 illustrates in greater detail an SSVT receiver 270 integrated with source drivers 270a . . . 270d of display panel 274. As shown, each EM signal 115a-115c is input into a decoder 280 where analog decoding is performed, and the recovered analog samples (i.e., voltages) are output directly to the level shifters, amplifiers and finally to the display of the mobile telephone. Effectively, the SSVT receiver 270 is made up of individual source drivers, each including a decoder, reconstruction bank, staging bank, and its own level shifters, amplifiers, etc. Each decoder is responsible for decoding the differential analog levels received over the transmission medium back into a format suitable for display. Once in the suitable format, the video content contained in the samples can be presented on a video display, frame after frame. As a result, the video capture from any video source can be re-created by a video sink. As shown, integrated receiver 270 does not require any DACs (for converting digital samples into analog samples for display) as required in prior art source drivers.

Each decoder 280 outputs to its corresponding collector 288 (reconstruction bank 282 and staging bank 286). P represents the number of input electromagnetic pairs, each pair carrying an SSVT signal independent from the others, except that they are isochronous signals, known to have been generated in lockstep with one another by encoders on the transmit side. Each decoder 280 performs the inverse transform of its paired encoder on the transmit side and reconstructs its input differential level signals into an output vector of N reconstructed samples (although single-ended inputs rather than differential inputs may be used). The collector 288 assigns the decoder output vector samples (or, “reconstructed samples”) to their predetermined positions in the analog samples 272. These samples 272 will be driven onto columns of the display as it shifted and amplified samples 273.

The P decoders 280 (labeled 0 through P−1) are arranged to receive differential EM signals0 through EM signalsP−1 respectively, 115a-115c. In response, each of the decoders 280 generates N differential pairs of reconstructed samples (Sample0 through SampleN−1). The number of samples, N, is equal to the number of orthogonal codes used for the earlier encoding i.e., there are N orthogonal codes used, meaning N codes from the code book.

Reconstruction banks 282 sample and hold each of the differential pairs of N reconstructed samples (Sample0 through SampleN−1) for each of the decoder output vectors at the end of each decoding interval respectively. These received differential pairs of voltage signals are then output as samples (SampleN−1 through Sample0) for each of the output vectors respectively. Each reconstruction bank may also convert from a differential pair to a single-ended voltage. As differential pairs are used to maintain accuracy in low voltages (they are more resistant to external influences than single-ended voltages), it can be preferable to convert into single-ended voltages as late as possible in the signal chain (by establishing a reference ground level). Thus, conversion to single-ended voltages need not occur in the reconstruction banks, but may occur later, such as in the column drivers, e.g., within the level shifters. Conversion is typically performed for all signals (samples, control signals, etc.) and may occur in different locations depending upon the signal type and implementation.

Each staging bank 286 receives all of the reconstructed samples (Samplen−1 through Sample0) from each of the decoder output vectors and serves as an analog output buffer. Once the samples are moved into staging bank 286 they are triggered by a latch signal 298 derived from the decoded EM signals. Once the samples are released from the staging bank 286 they are sent to level shifters 290.

Also included are a channel aligner 287 and a staging controller 289 that receives framing information and aperture information from each decoder 280. The framing signal 295 signifies the timing for constructing video frames and is sent on to the display panel. The staging controller 289 coordinates the timing of the staging banks 286 to ensure that all the samples come from a common time interval in which the level signals were sent by the SSVT transmitter. As a result, the individual channels of the transmission medium do not necessarily have to all be the same length since the channel aligner 287 and staging controller 289 compensate for any timing differences. The staging controller 289 also keeps track and provides to the staging banks 286 the proper permutation selection to use.

The SSVT receiver decodes the SSVT signals and outputs numerous reconstructed analog voltage samples in parallel from its collector 288. Because these analog outputs may not be in the voltage range required by the display panel they may be input into level shifters 290 which shifts the voltages into a voltage range for driving the display 274 using an analog transformation; amplification may occur as well using amplifiers 291. Any suitable level shifters may be used as known in the art, such as latch type or inverter type and amplifiers are known in the art. Level shifting and amplification typically occurs in the column drivers of the display.

By way of example, the voltage range of each sample coming out of the collector 288 may be 0 to 1 V and the voltage range coming out of the level shifters 290 may be −8 up to +8 V (using the inversion signal 296 to inform the level shifters to flip the voltage every other frame, i.e., the range will be −8 to 0 V for one frame and then 0 V to +8 V for the next frame). In this way, the EM signals do not need to have their voltages flipped every frame; the SSVT receiver provides a positive voltage range (for example) and the level shifters flip the voltage every other frame as expected by the display panel. The SSVT receiver may also implement line inversion and dot inversion. The inversion signal tells level shifters which voltages to switch. Some display panels such as OLED do not require this voltage flipping every other frame in which case the inversion signal is not needed and the level shifters do not flip voltages every other frame. Display panels such as LCD do require this voltage flipping. The inversion signal 296 is recovered from the EM signals.

Input into the level shifters from staging controller 289 can be gain and gamma values 297; gain determines how much amplification is applied and the gamma curve relates the luminous flux to the perceived brightness which linearizes human's optical perception of the luminous flux. Typically, in prior art source drivers both gain and gamma are set values determined by the manufactured characteristics of a display panel. In the analog level shifters 290 gain and gamma may be implemented as follows. Gamma may be implemented in the digital part of the system and level shifting and gain are implemented by setting the output stage amplification. In the case of gamma, implementation is also possible in the output driver, by implementing a non-linear amplification characteristic. (Another gamma correction is also performed in the timing controller or system-on-chip, but that gamma correction is not described here.)

Once shifted, the samples 292 are input into amplifiers 291 which amplify each sample to the correct voltage range required by the particular display. Once amplified, the samples 273 are output and are used to drive the source electrodes in their corresponding column of the display panel as is known in the art.

In order to properly encode an SSVT signal for eventual display on a particular display various physical characteristics or properties of that display are needed by the IVI (or other display controller) or whichever entity performs the SSVT encoding. These physical characteristics 284 include, among others, resolution, tessellation, backlight layout, color profile, aspect ratio, and gamma curve. Resolution is a constant for a particular display; tessellation refers to the way of fracturing the plane of the display into regions in a regular, predetermined way and is in units of pixels; backlight layout refers to the resolution and diffusing characteristic of the backlight; color profile is the precise luminance response of all primary colors, providing accurate colors for the image; and the aspect ratio of a display will have discrete, known values.

These physical characteristics of a particular display may be delivered to, hardwired into, or provided to a particular display controller in a variety of manners. In one example, signals 284 deliver values for these physical characteristics directly from the display (or from another location) to the SSVT transmitter. Or, an SSVT transmitter associated with a particular display comes with these values hardcoded within the transmitter. Or, a particular display controller is meant for use with only particular types of displays and its characteristic values are hardcoded into that display controller.

Input to the display can also be a backlight signal 285 that instructs the LEDs of the backlight, i.e., when to be switched on and at which level. In other words, it is typically a low-resolution representation of an image meaning that the backlight LEDs light up where the display needs to be bright and they are dimmed where the display needs to be dim. The backlight signal is a monochrome signal that can also be embedded within the EM signals, i.e., it can be another parallel and independent EM signal traveling along with the other parallel EM signals (for example) and may be low or high resolution.

Also output from channel aligner 287 is a gate driver control signal 294 that shares timing and control information with gate drivers typically on the left edge of the display in order to synchronize the gate drivers with the source drivers. Typically, each SSVT receiver includes a timing acquisition circuit that obtains the same timing and control information for the gate drivers and one or more of the source driver flex foils (typically leftmost and/or rightmost source driver) will conduct that timing and control information to the gate drivers. The timing and control information for the gate drivers may be embedded within one of the EM signals and is recovered from that signal using established spread spectrum techniques.

Typically, a conventional source driver of a display is connected directly to glass using “COF” (Chip-on-Flex or Chip-on-Foil) integrated circuit packages. It is possible to replace these source drivers by the novel SSVT receiver integrated with source drivers described herein, thus turning an existing display into an SSVT-enabled display. The inputs of these ICs are usually connected together by a PCBA, providing the input signals from a video source and timing controller. These can be close to or far away from the display, transferring the video and control signals across an inexpensive wire.

### Spread-Spectrum Data Transport Between LiDAR Sensor and Processor

As mentioned above, one embodiment of the present invention uses spread-spectrum data transport (SSDT) to transport LiDAR data from a LiDAR sensor to an ADAS processor of the vehicle. Similar to transport of video data, transport of LiDAR data makes use of a version of the SSVT transmitter of FIG. 3, albeit transmitting signals representing LiDAR data rather than video, hence the nomenclature SSDT instead of SSVT. It is believed that SSDT is preferable for LiDAR transport due to the length of cables and noise.

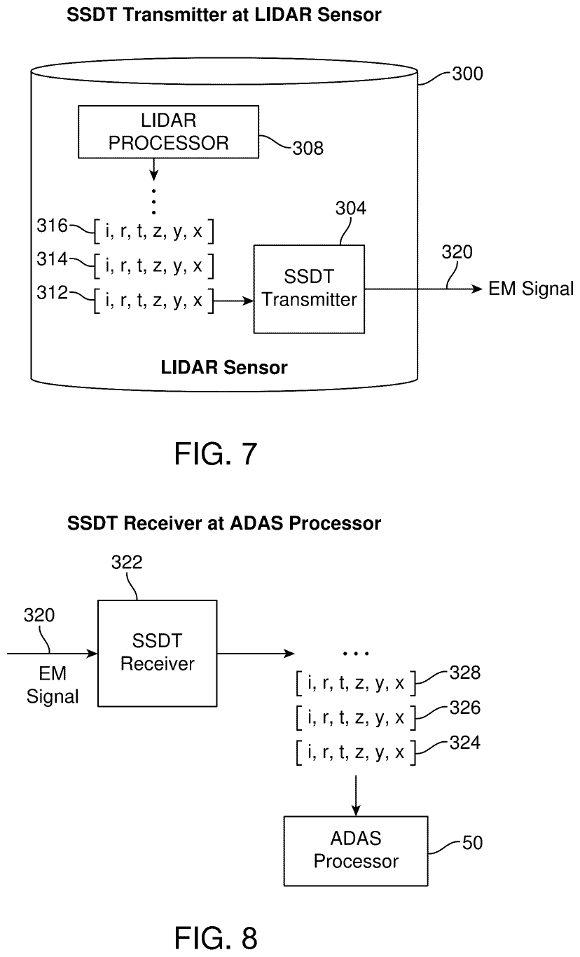

FIG. 7 illustrates an SSDT transmitter at a LiDAR sensor. As known in the art, a LiDAR sensor 300 in a vehicle emits laser pulses, measures the time it takes for those pulses to return after bouncing off nearby objects, processes that data, and then outputs resultant data to a processor of the vehicle. Typically, this output data will include point cloud data, namely the X, Y and Z coordinates representing the distances to objects or surfaces within its field of view, and optionally a timestamp (t) for each data point indicating when that data point was measured, reflectivity (r), and intensity (i). The timestamp allows the receiving processor to reconstruct more accurately the three-dimensional scene around the vehicle. Reflectivity is a measure of how much light or laser energy is reflected back from a particular point on an object or surface; higher reflectivity indicates surfaces that reflect more light. Intensity refers to the strength or magnitude of the returned laser pulse from a specific point; its value can vary based upon distance, material, and sensor settings.

As shown, processor 308 of the LiDAR sensor outputs a continuous stream of data values for each point in the point cloud; shown in order of their output are sets of data values 312, 314 and 316 representing three points in the point cloud. The order in which the data values are output from the processor 308 depends upon the scanning pattern and configuration of sensor 300; a variety of scanning patterns may be used. By way of example, the scanning pattern may be a 360° sweep in which the laser beam is swept in a full circle around the vehicle, changing the vertical angle as a sensor sweeps, thus capturing data at different heights. Or, a multilayer scanning pattern may be used in which multiple laser beams scan at varying angles in order to capture data at different heights simultaneously; or, any fixed a custom scanning pattern may be used depending upon the design of the LiDAR sensor and its particular application. No matter the scanning pattern, the particular order of output of the data values from processor 308 is also known a priori by any corresponding SSDT receiver (or the ADAS processor) of LiDAR data (shown below) in order to properly organize and interpret that LiDAR data. Typically, the LiDAR sensor itself will convert the received laser reflections into digital data in order that the processor 308 can produce the 3-D coordinates, timestamp, reflectivity and intensity also in digital format.

Turning now to a discussion of the SSDT transmitter 304, it is preferably implemented as is the SSVT transmitter of FIG. 3, except that instead of RGB inputs, the inputs are sets of data values 312-316, etc. and DACs 224 will be present. Preferably, transmitter 304 outputs a single EM signal 320 (meaning only a single input vector and encoder are used) in order to minimize wiring, although it is certainly possible to include two or more output EM signals as shown in FIG. 3. SSDT transmitter 304 inputs sets of data values 312-316 sequentially in the order shown, each particular data value being input serially into the transmitter, e.g., the data values 312 are input in the order x, y, z, t, r, i, and then distributed into the input vector or vectors of the assembly bank according to the permutation used. If the data values x, y, z, t, r, i, are presented to the transmitter 304 in parallel, they may also be distributed into the input vector or vectors using a particular permutation. Additional data values per data point may also be input per set of data values, and each input set may be limited to only the x, y and z coordinates. And, even though transmitter 304 is shown within the housing of the LiDAR sensor 300, it may be located external to LiDAR sensor 300.

As previously discussed with reference to FIG. 3, EM signal 320 thus represents the input LiDAR data values in a stream of analog levels transmitted over any suitable electromagnetic pathway such as wire, cable, optical fiber, wireless, etc. EM signal 320 is transmitted, for example, from a LiDAR sensor 300 through vehicle 10 to an intermediate processor 42 or directly to ADAS processor 50 where it is received at a corresponding SSDT receiver.

FIG. 8 illustrates an SSDT receiver at processor 50 of vehicle 10. EM signal 320 is received at SSDT receiver 322 from the corresponding SSDT transmitter of FIG. 7. SSDT receiver 322 is preferably implemented as is SSVT receiver 120 of FIG. 4 except that its outputs will not be RGB values, but rather data values 324-328, etc. as shown and the ADCs will be present. Sets of data values 324-328 are output serially or in parallel in the order shown, i.e. output set 324 corresponds to input set 312, etc. As shown, only a single EM signal 320 is input into the receiver, meaning that there will be a single decoder and output vector, although if transmitter 304 outputs numerous EM signals, there will be a corresponding number of input EM signals at receiver 322. Further, receiver 322 is aware of the permutation used by transmitter 304 and is able to output data values 324-328 in the order in which they were input. As disassembly bank 258 holds each output vector or vectors, the data values in a particular set may be read out from that output vector in parallel or serially, depending upon the needs of processor 50. And, even though receiver 322 is shown external to processor 50 it may be located within an ADAS system, on the same board or same chip as processor 50.

### Spread-Spectrum Data Transport Between Radar Sensor and Processor

As mentioned above, one embodiment of the present invention uses spread-spectrum data transport (SSDT) to transport radar data from a radar sensor to an ADAS processor of the vehicle. Similar to transport of video data, transport of radar data makes use of a version of the SSVT transmitter of FIG. 3, albeit transmitting signals representing radar data rather than video, hence the nomenclature SSDT instead of SSVT. It is believed that SSDT is preferable for radar transport due to the length of cables and noise.

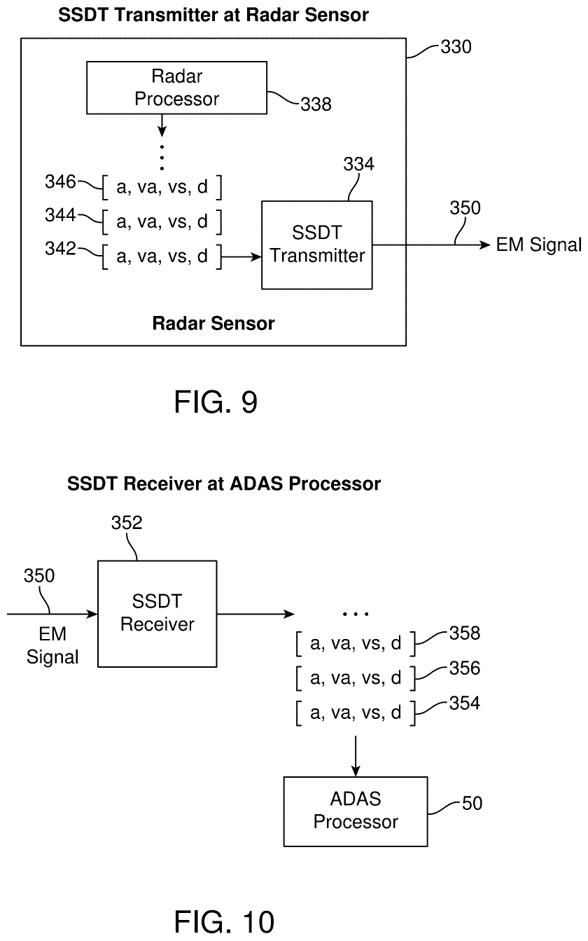

FIG. 9 illustrates an SSDT transmitter at a radar sensor. As known in the art, a radar sensor 330 in a vehicle emits radio waves and receives their reflections (the raw radar echoes) in order to detect and track objects in the vicinity of the vehicle. The raw radar echoes are processed internally at a processor 338 that then outputs resultant data to a processor of the vehicle. Typically, for each object detected, this output data will include: a distance measurement (d) indicating how far the object is from the vehicle; the relative velocity of that object which includes a magnitude indicating the speed (vs) of the object relative to the vehicle, and an angle (va) indicating the object's direction relative to the orientation of the radar sensor; and an azimuth angle (a) which gives the position of the detected object relative to the vehicle. Other data may be provided and may include an elevation angle indicating the vertical angle at which an object is detected, and an object classification which may include an estimate as to the size, shape and particular movements of the object. For a radar sensor mounted at the front of the vehicle and facing directly forward, it is possible that the data may only include the distance to the object.

As shown, processor 338 of the radar sensor outputs a continuous stream of sets of data values for the objects detected; shown in order of their output are sets of data values 342, 344 and 346 representing three sets of data. These sets of data values may represent a single object which is being tracked continuously, multiple objects which are being tracked, or a mixture of both.

The order in which the data values are output from the processor 338 depends upon the design and particular scanning method used by the radar sensor; two primary scanning methods are used. In continuous wave radar (CWR) the sensor continuously emits radio waves and the sensor antenna scans using a conical scan (continuously sweeping the field of view and reporting objects detected at different azimuth angles in sequence) or electronic scanning (allowing for a more flexible scanning pattern). Or, frequency modulated continuous wave (FMCW) radar is used and the scanning pattern may include sweeping frequency (objects detected at different distances are reported sequentially) or multiple beams (writing data on multiple objects at once). No matter the scanning pattern used, the particular order of output of the sets of data values from processor 338 (and the scanning pattern) is also known a priori by any corresponding SSDT receiver (or the ADAS processor) of radar data (shown below) in order to properly organize and interpret that radar data. In addition, even if the scanning pattern is not known by the receiver, the distance and azimuth angle data tells the receiver where the object is. Typically, the radar sensor itself will convert the received raw radar data into digital data in order that the processor 338 can produce the distance, velocity and azimuth angle data.

Turning now to a discussion of the SSDT transmitter 334, it is preferably implemented as is the SSVT transmitter of FIG. 3, except that instead of RGB inputs, the inputs are sets of data values 342-346, etc. and DACs 224 will be present. Preferably, transmitter 334 outputs a single EM signal 350 (meaning only a single input vector and encoder are used) in order to minimize wiring, although it is certainly possible to include two or more output EM signals as shown in FIG. 3. SSDT transmitter 334 inputs sets of data values 342-346 sequentially in the order shown, each particular data value being input serially into the transmitter, e.g., the data values 342 are input in the order d, vs, va, a, and then distributed into the input vector or vectors of the assembly bank according to the permutation used. If the data values d, vs, va, a, are presented to the transmitter 334 in parallel, they may also be distributed into the input vector or vectors using a particular permutation. Additional data values per data point may also be input per set of data values, and each input set may be limited to only the distance measurement. And, even though transmitter 334 is shown within the housing of the radar sensor 330, it may be located external to radar sensor 330.

As previously discussed with reference to FIG. 3, EM signal 350 thus represents the input radar data values in a stream of analog levels transmitted over any suitable electromagnetic pathway such as wire, cable, optical fiber, wireless, etc. EM signal 350 is transmitted, for example, from a radar sensor 330 through vehicle 10 to an intermediate processor 42 or directly to ADAS processor 50 where it is received at a corresponding SSDT receiver.

FIG. 10 illustrates an SSDT receiver at processor 50 of vehicle 10. EM signal 350 is received at SSDT receiver 352 from the corresponding SSDT transmitter of FIG. 9. SSDT receiver 352 is preferably implemented as is SSVT receiver 120 of FIG. 4 except that its outputs will not be RGB values, but rather sets of data values 354-358 as shown and the ADCs will be present. Sets of data values 354-358 are output serially or in parallel in the order shown, i.e. set 354 corresponds to set 342, etc. As shown, only a single EM signal 350 is input into the receiver, meaning that there will be a single decoder and output vector, although if transmitter 334 outputs numerous EM signals, there will be a corresponding number of input EM signals at receiver 352. Further, receiver 352 is aware of the permutation used by transmitter 334 and is able to output sets of data values 354-358, etc. in the order in which they were input. As disassembly bank 258 holds each output vector or vectors, the data values in a particular set may be read out from that output vector in parallel or serially, depending upon the needs of processor 50. And, even though receiver 352 is shown external to processor 50 it may be located within an ADAS system, on the same board or same chip as processor 50.

### Spread-Spectrum Data Transport Between Ultrasonic Sensor and Processor

As mentioned above, one embodiment of the present invention uses spread-spectrum data transport (SSDT) to transport ultrasonic data from an ultrasonic sensor to an ADAS processor of the vehicle. Similar to transport of video data, transport of ultrasonic data makes use of a version of the SSVT transmitter of FIG. 3, albeit transmitting signals representing ultrasonic data rather than video, hence the nomenclature SSDT instead of SSVT. It is believed that SSDT is preferable for ultrasonic transport due to the length of cables and noise.

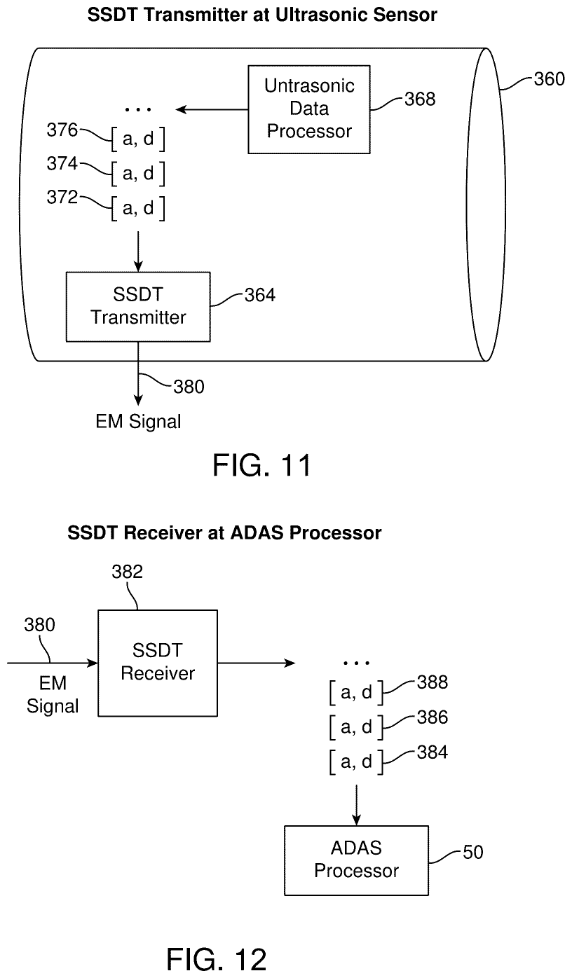

FIG. 11 illustrates an SSDT transmitter at an ultrasonic sensor. As known in the art, an ultrasonic sensor 360 in a vehicle emits high-frequency sound waves and receives their reflections in order to detect and track objects in the vicinity of the vehicle. The raw ultrasonic data (including the measured time to receive reflections) is processed internally at a processor 368 that then outputs resultant data to a processor of the vehicle. Typically, for each object detected, this output data may include: a distance measurement (d) indicating how close the object is to the vehicle; an angle (a) indicating the object's direction relative to the orientation of the sensor; and signal strength, indicating the surface characteristics of the detected object. Other data may be provided and may include whether or not an object is detected within the sensor's range, the number of objects detected within its range in the raw ultrasonic data (the actual ultrasonic echoes and waveforms received by the sensor). For an ultrasonic sensor mounted on the vehicle and having a known orientation with respect to the vehicle (e.g. facing directly outward), it is possible that the data may only include the distance to the object. As shown, processor 368 of the ultrasonic sensor outputs a continuous stream of sets of data values for the object or objects detected; shown in order of their output are sets of data values 372, 374 and 376 representing three sets of data. These data values may represent a single object which is being tracked continuously, multiple objects which are being tracked, or a mixture of both.

The order in which the data values are output from the processor 368 typically depends upon the order in which the sound waves are emitted, e.g. the first sound wave emitted results in data values set 372, the second wave results in data values set 374, etc. No matter the order used, the particular order of output of the data values from processor 368 is also known a priori by any corresponding SSDT receiver (or the ADAS processor) of ultrasonic data (shown below) in order to properly organize and interpret that ultrasonic data. In addition, even if the order is not known by the receiver, the distance data tells the receiver where the object is in relation to the sensor. Typically, the ultrasonic sensor itself will convert the received raw ultrasonic data into digital data in order that the processor 368 can produce the distance and angle data.

Turning now to a discussion of the SSDT transmitter 364, it is preferably implemented as is the SSVT transmitter of FIG. 3, except that instead of RGB inputs, the inputs are sets of data values 372-376, etc. and DACs 224 will be present. Preferably, transmitter 364 outputs a single EM signal 380 (meaning only a single input vector and encoder are used) in order to minimize wiring, although it is certainly possible to include two or more output EM signals as shown in FIG. 3. SSDT transmitter 364 inputs data values 372-376, etc. sequentially in the order shown, each particular data value being input serially into the transmitter, e.g., the data values 372 are input in the order d, a, and then distributed into the input vector or vectors of the assembly bank according to the permutation used. If the data values d, a, are presented to the transmitter 364 in parallel, they may also be distributed into the input vector or vectors using a particular permutation. Additional data values per object may also be input per set of data values, and each input set may be limited to only the distance measurement. And, even though transmitter 364 is shown within the housing of the ultrasonic sensor 360, it may be located external to ultrasonic sensor 360.

As previously discussed with reference to FIG. 3, EM signal 380 thus represents the input ultrasonic data values in a stream of analog levels transmitted over any suitable electromagnetic pathway such as wire, cable, optical fiber, wireless, etc. EM signal 380 is transmitted, for example, from an ultrasonic sensor 360 through vehicle 10 to an intermediate processor 42 or directly to ADAS processor 50 where it is received at a corresponding SSDT receiver.

FIG. 12 illustrates an SSDT receiver at processor 50 of vehicle 10. EM signal 380 is received at SSDT receiver 382 from the corresponding SSDT transmitter of FIG. 11. SSDT receiver 382 is preferably implemented as is SSVT receiver 120 of FIG. 4 except that its outputs will not be RGB values, but rather sets of data values 384-388, etc. as shown and the ADCs will be present. Sets of data values 384-388 are output serially or in parallel in the order shown, i.e. output set 384 corresponds to input set 372, etc. As shown, only a single EM signal 380 is input into the receiver, meaning that there will be a single decoder and output vector, although if transmitter 364 outputs numerous EM signals, there will be a corresponding number of input EM signals at receiver 382. Further, receiver 382 is aware of the permutation used by transmitter 364 and is able to output data values 384-388, etc. in the order in which they were input. As disassembly bank 258 holds each output vector or vectors, the data values in a particular set may be read out from that output vector in parallel or serially, depending upon the needs of processor 50. And, even though receiver 382 is shown external to processor 50 it may be located within an ADAS system, on the same board or same chip as processor 50.

### Sampled Analog Video Transport Between Camera and Processor

As mentioned above, one embodiment of the present invention uses sampled analog video transport (SAVT) to transport video data from a camera of the vehicle to a processor such as an IVI processor or an ADAS processor.

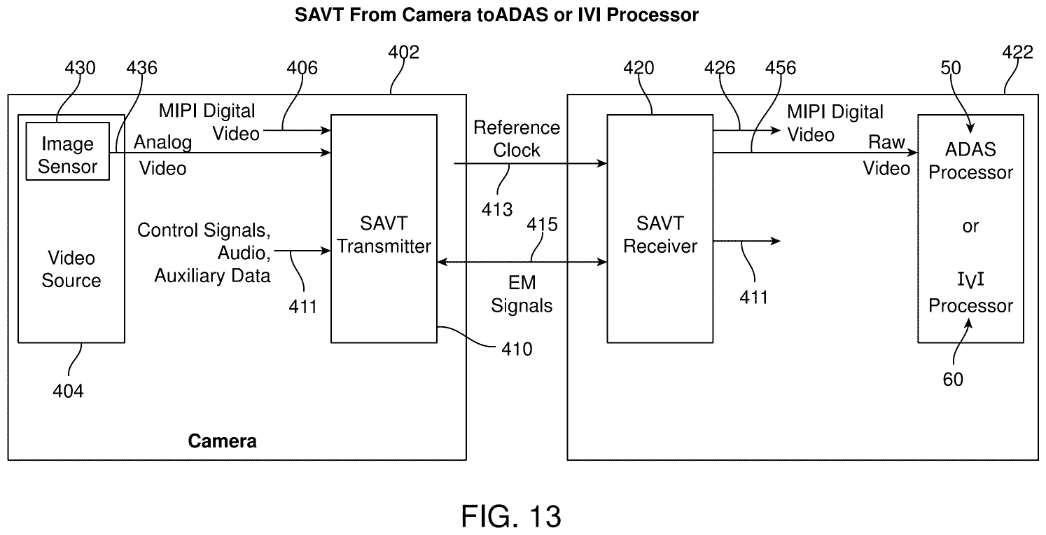

FIG. 13 illustrates video transport from a camera of a vehicle to an ADAS or IVI processor. As shown, video source 404 (such as any camera on the vehicle of FIG. 1) outputs digital video data 406 using a standard such as MIPI to an SAVT transmitter 410. The transmitter outputs any number of electromagnetic (EM) signals 415 to a corresponding SAVT receiver 420 located at an ADAS processor 50 or at an IVI processor 60 and outputs digital video data 426 using the same MIPI standard via a suitable interface. Transmitter 410 may be located upon the same circuit board as a video source, located in close proximity to the video source, located within a camera module of camera 402, or may be located external to the camera, etc. The receiver 420 may be integrated within the processor, located on the same circuit board as the processor, within the same module, or in close proximity to the processor.

As known in the art, the MIPI digital video data 406 is raw data from the image sensor 430, i.e., it is the raw pixel data after conversion to digital, but before color interpolation (e.g., a row of samples BGBG . . . followed by a row samples RGRG . . . ). EM signals 415 may be any number of signals, each over a suitable electromagnetic pathway, such as a twisted wire pair (shielded or unshielded), cable, wireless, or fiber optic. In one particular embodiment, a single EM signal 415 is transmitted over a single unshielded twisted wire pair (UTP).

SAVT replaces transport via GMSL, i.e., SSVT transmitter 410 replaces a GMSL serializer and SSVT receiver 420 replaces a GMSL deserializer. In addition to replacing GMSL3 transport as shown, the SAVT transmitter and receiver may also replace FPD-Link IV, Auto E-Net, and MIPI A-PHY transport between camera and the ADAS or IVI processor. SAVT transmitter 410 may be an integrated circuit that replaces an existing chip (e.g., a GMSL3 serializer chip) and SSVT receiver 420 may likewise replace an existing chip.

Further, an interface other than MIPI may be used to output video data from the video source, such as DSI, HDMI, DP, OLDI, par, and these other interfaces may output video data in formats such as those described herein.

In an alternative embodiment, instead of digital video signals being delivered to the transmitter 410 via a MIPI interface (or other interface), SAVT transmitter 410 is integrated with the video source and image sensor and receives the raw analog video data directly from image sensor 430 as a series of analog video samples 436. In other words, as the rows of analog video samples are read out from the image sensor (e.g., a row of samples BGBG . . . followed by a row samples RGRG . . . ) these analog video samples 436 are directly input into SAVT transmitter 410, thereby eliminating any ADCs within the video source as well eliminating the MIPI interface and the need to convert the digital samples at the SAVT transmitter into analog. Once received at receiver 420, these raw analog video samples 436 may be output as raw video samples 456 (digital or analog) into processor 50 or processor 60.

In addition to sending a payload of video samples, any number and type of control signals or other data 411 may be input into SAVT transmitter 410 for transmission to the receiver for use at ADAS or IVI processor at a display. These other signals and data may be input into the transmitter as if they were video samples and are distributed and transmitted as if they were video samples. Since the SAVT receiver will know a priori which these control signals and data are, and where they will be inserted into the vectors of the transmitter (i.e., the specific permutation that the transmitter uses), the receiver is able to extract these control signals and data. If the video is digital then these other signals are digital as well, if the video is analog, then these other signals are analog as well. These other signals and auxiliary data may include: audio, Ethernet, control signals (such as GPIO, I2C, UART), video-specific control (e.g., frame synchronization), and clock signals.

In one particular embodiment a microcontroller (such as a vehicle MCU) provides a reference clock 413 separate from EM signals 415 to source drivers in SAVT receiver 420, i.e., each source driver chip (e.g. a Hyphy HY1002 chip) has a clock input that is provided by the MCU. This reference clock may be relatively low frequency, around 10.5 MHz, for example. The clock may also be provided by a microprocessor of the camera or transmitter 410 or may be a clock recovered from a GMSL network (or other network).

Preferably, reference clock 413 (with embedded data) between transmitter and receiver is used to ensure signal integrity of the EM signals 415. Such a reference clock may be recovered from an HDMI signal or from any other video source, including source 404. The SAVT system shown in FIG. 13 does not use the clock 413 directly but uses a much lower frequency version (e.g. divided by 16). This means a frequency in the 10-20 MHz range, but since the wavelength at this frequency is approximately 15 meters, nothing is likely to radiate significantly (unless slopes are exceedingly steep). Embedding the reference clock in the SAVT signal (and then performing clock recovery) avoids needing a separate, global reference clock and can work. The embedded clock signal, though, and the additionally-embedded side-channel data will have a negative impact on the EM signal integrity. Therefore, it is preferable to have a separate (albeit slower) reference clock with embedded data as described above.

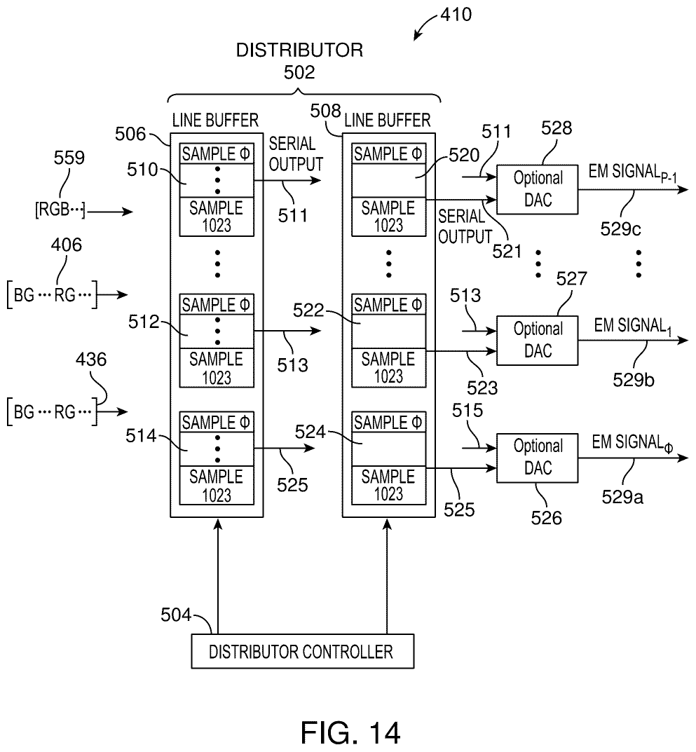

FIG. 14 illustrates an architecture of SAVT transmitter 410 at a video source. Shown is a distributor 502 that includes two line buffers 506 and 508 having input vectors, a distributor controller 504, optional digital-to-analog converters 526-528, and an analog EM signal 529a-529c output from each input vector. In this example there are multiple EM pathways; there may be a single EM pathway or multiple EM pathways. Depending upon the implementation and design decisions, multiple outputs may increase performance but require more pathways. In order to have as few wires as possible from transmitter 410, only a single pathway transporting a single EM signal 529c may be used, meaning only one input vector per line buffer.

In general, as a stream of video samples are received at transmitter 410 from the sensor (using any suitable order), the video samples are repeatedly (1) distributed to one of the EM pathways according to a predetermined permutation (in this example, row major order, i.e., the identity permutation) and (2) sent as an analog EM signal over a transmission medium, one EM signal per EM pathway. As a result, the original stream of time-ordered video samples containing color and pixel-related information is conveyed from video source to video sink. An inverse permutation at a corresponding SAVT receiver effectively outputs the incoming samples in the same order that the samples were received at the distributor. The samples may arrive serially, e.g., R then G then B, or in parallel i.e., RGB in parallel. Using distributor 502, we can reorder the samples as needed. A circuit such as a shift register or similar may be used to distribute the samples into the line buffers according to a permutation.

As explained earlier with respect to FIG. 3, input are either the digital BG . . . RG . . . samples 406 (one color sample per pixel of the image sensor) or the analog BG . . . RG . . . samples 436 read out directly from the image sensor. If the samples are digital then DACs 526-528 are used. In general, the transmitter can accept analog or digital video samples from any color space used, not necessarily RGB.

Distributor 502 is arranged to receive the pixel color information exposed in the input sets of samples. The distributor 502 takes the exposed color information and writes multiple input vectors 510, 512, 514 into the first line buffer 506 (one input vector per EM pathway) according to the predefined permutation. Once line buffer 506 is full then each input vector 510, 512, 514 is read out via its corresponding serial output port 511, 513, 515 onto its corresponding pathway 529a-529c. As these input vectors from line buffer 506 are being read out (or once line buffer 506 is full) then the next line of input samples are written into input vectors 520, 522, 524 in the second line buffer 508. Thus, once the second line buffer 508 is full, samples from the second line buffer 508 are output via their serial output ports 521, 523, 525. This writing to, and reading from, the first and second line buffers continues in this “ping-pong” fashion as long as input samples arrive at the transmitter.

The number of line buffers required depends on the relative time required to load the buffers and then to unload them. There is a continuous stream of data coming in on the inputs 559, 406 or 436. If it takes time T to load all the samples into a buffer and the same time T to unload them, we use two buffers (so that we can unload one while the other is being loaded). If the time taken to unload becomes shorter or longer, the buffer length can always be adjusted (i.e., adjust the number of input vectors or adjust N of each input vector) so that the number of line buffers required is always two. Nevertheless, more than two buffers may be used if desired.

Distributor controller 504 controls the operation and timing of the line buffers. In particular, the controller is responsible for defining the permutation used and the number of samples N when building the input vectors. In this example, N=1024. Of course, the number of input vectors per line buffer and the number of samples N per input vector may vary widely depending upon the embodiment being implemented, the type of signals being input, bandwidth desired, whether the transmitter is implemented at the camera or elsewhere, etc.

Controller 504 may also include a permutation controller that controls distribution of the samples to locations in the input vectors. The controller is also responsible for coordinating the clock domain crossing from a first clock frequency to a second clock frequency. In one particular embodiment, the samples are clocked in at a frequency of FPIXEL and the samples are clocked out serially from each input vector at a sampled analog video transport (SAVT) frequency of FSAVT. It is also possible to clock in two samples at a time instead of one each, or three at a time, etc. The analog samples are transmitted along an electromagnetic pathway of a transmission medium as analog EM signals 529a-529c to the SAVT receiver.

For purposes of explanation, one possible permutation is one in which each of the input vectors includes N samples of color information. The exposed samples of the sets of samples in this example are assigned to input vectors from left to right. For example, the “R”, “G”, “G” and “B” values of the first set of samples, the “R”, “G”, “G” and “B” values of the next set of samples, etc. are assigned to input vector 280 in that order (i.e., RGGBRGGB, etc.). Once input vector 510 has been assigned its N samples, the above process is repeated for the other input vectors in order until each of the input vectors has N values. The number of N values per input vector may widely vary. As shown in this example, this predetermined permutation preserves the row-major order of the incoming samples, that is, the first input vector 510 includes sample0 through sample1023 of the first row in that order and the succeeding input vectors continue that permutation. Thus, distributor controller 504 performs a permutation by assigning the incoming samples to particular addresses within the line buffer. It should also be understood that any permutation scheme may be used by the distributor 504, and, whichever permutation scheme that is used by the transmitter, its inverse will be used by the corresponding SAVT receiver. In the situation where only one electromagnetic pathway is used and where the video samples are received at the SAVT transmitter, the distributor writes into one input vector in each line buffer.

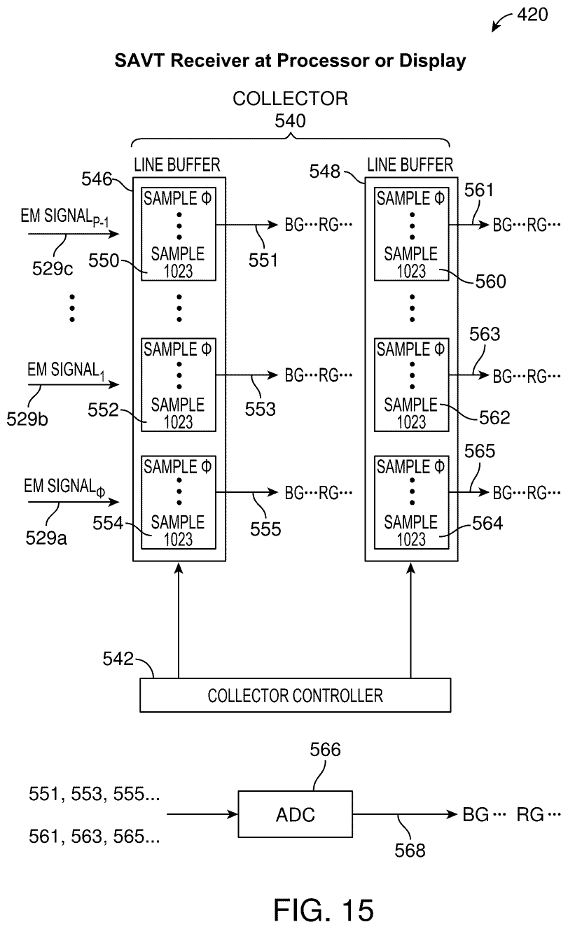

FIG. 15 illustrates an SAVT receiver 420. The receiver receives any number of EM signals 529a-529c and inputs those into a collector 540 that has two line buffers 546 and 548. Similar to the distributor of the SAVT transmitter of FIG. 14, each line buffer has any number of output vectors 550, 552, 554 (or 560, 562, 564), each vector holding any number of video samples corresponding to the input vectors. In operation, the first line buffer 546 is first filled from top to bottom and while it is outputting its samples (one vector at a time, e.g., 551, 553, 555) the second line buffer 548 is being filled. In other words, output vector 550 outputs its samples 551 followed by the samples 553 of vector 552, etc. Once the first line buffer is empty it begins refilling while the second line buffer outputs its samples. Each output vector outputs its samples one at a time via analog-to-digital converter (ADC) 566 in order to provide a continuous stream of digital samples 568, which may be converted using a suitable interface into a standard such as MIPI digital video 426 to be input into the processor. The collector controller 542 sequences the loading of samples from the inputs 529a-529c, as well as controls the timing for unloading the samples for further processing. Since the input stream is continuous, the collector controller loads samples into one line buffer while the other line buffer samples are transferred to the output for further processing.

As with the SAVT transmitter of FIG. 14, there are preferably two line buffers but more may be used if necessary and the buffer length may be adjusted as mentioned. In the case of collector 540, the output is serial, but the output from each buffer may be in parallel (i.e., all N samples at a time from each output vector) and may take a longer time to output per sample than does the input sampling. Thus, if you output 100 samples at a time, you can transfer to output 100 times more slowly than the input sampling (assuming the input sampling were one at a time).

Shown is an embodiment of receiver 420 suitable for use with the embodiment of FIG. 13 in which digital samples 406 are input to the SAVT transmitter shown in FIG. 14 and then output serially from the line buffers in the same format as input, namely, BG . . . RG . . . . Once output, the samples are sent on to ADC 566 and output as MIPI digital video 426 using a suitable interface. Whichever permutation is used in the corresponding SAVT transmitter in order to distribute samples into the line buffers, the inverse permutation is used in the SAVT receiver such that samples are output in the order they were received at the SAVT transmitter.

If raw analog samples 436 are transported (e.g., BG . . . RG . . . samples 436 which had been read out directly from the image sensor), then ADC 566 may be used and the raw video 456 input to the processor is digital samples, or ADC 566 is not used and the raw video 456 input to the processor is analog samples.

### Sampled Analog Video Transport Between Processor and Display

As mentioned above, one embodiment of the present invention uses sampled analog video transport (SAVT) to transport video data from a processor such as an IVI processor to a display in the vehicle.

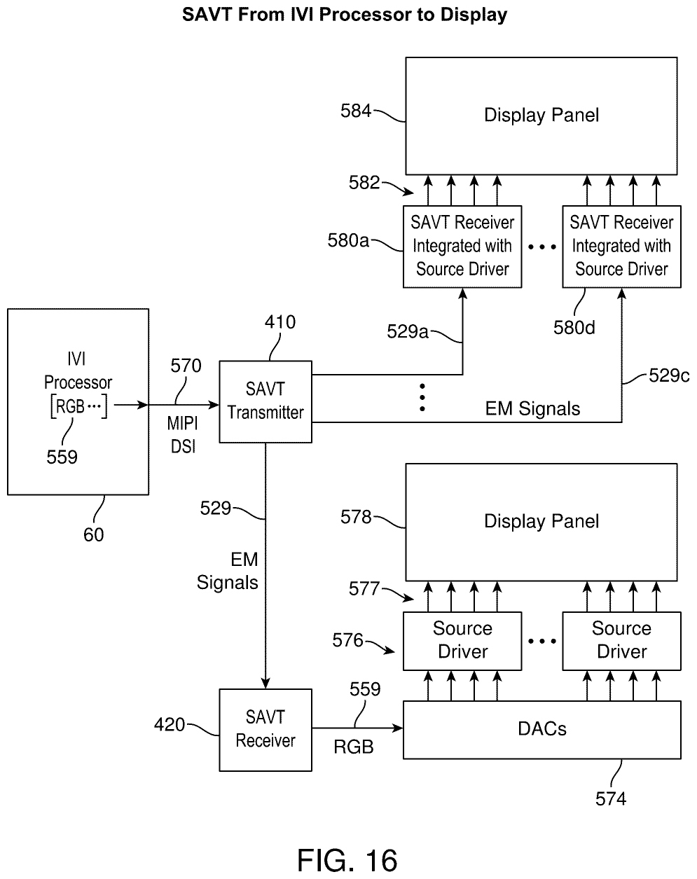

FIG. 16 illustrates a first embodiment in which video data is transported to a legacy display panel 578 and a second embodiment in which video data is transported to a novel display panel 584 in which an SAVT receiver is integrated with each source driver. An IVI processor 60 sends video data (e.g., digital RGB signals 559) over an MIPI DSI interface 570 (or over any other suitable interface) to SAVT transmitter 410 which in a first embodiment transports the video data over any number of EM signals 529 to SAVT receiver 420. SAVT receiver 420 outputs RGB signals 559 into DACs 574, and is known in the art, DACs 574 convert the signals into analog which are then presented to source drivers 576 which drive individual columns 577 of display panel 578. In a second embodiment, SAVT transmitter 410 transmits the video data over any number of EM signals 529a-529c each to an SAVT receiver integrated within a source driver 580a . . . 580d as will be explained in greater detail below. Each source driver then drives individual columns 582 of display panel 584. Thus, transmitter 410 transmits to as many source drivers as there are EM signals.

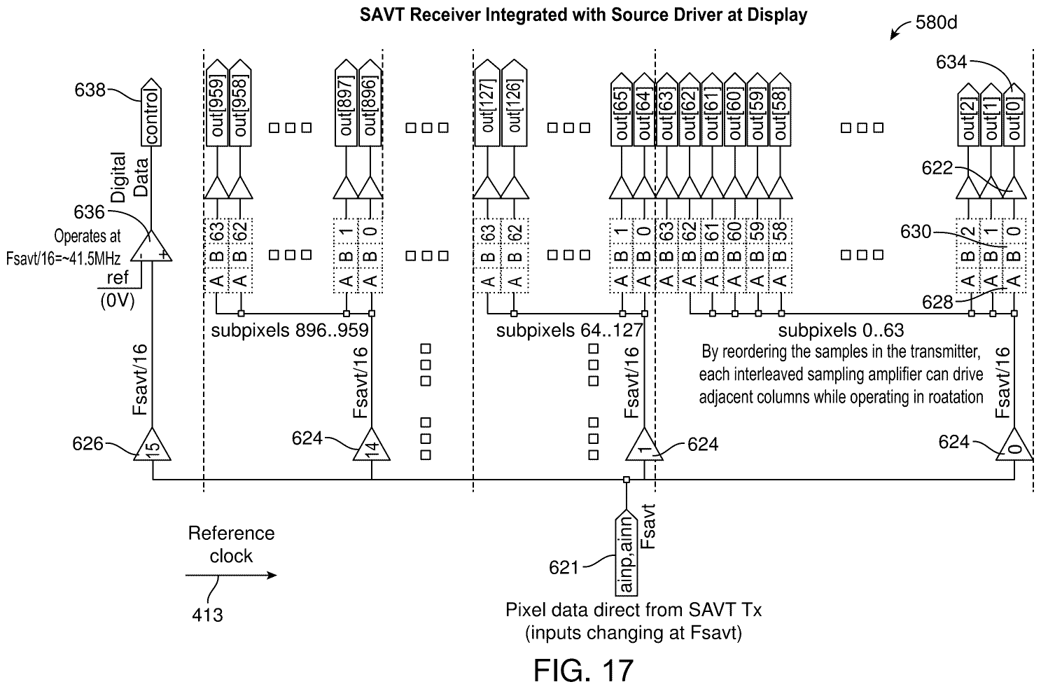

FIG. 17 illustrates in greater detail an SAVT receiver integrated with source driver 580d of display panel 584 (shown in FIG. 16), each of the other receivers 580a, etc. being implemented in a similar manner and driving its respective columns. In this architecture, each amplifier drives adjacent columns and all control signals are handled by a single amplifier, the advantage being that the columns being collected are relatively local to a S/H amplifier. But other permutations of amplifiers with respect to columns are possible, for example, a permutation may be used to minimize the transmission bandwidth to the input (Ainp, Ainn); there are a large number of other possible permutations (maps) from input sample number to column. Alternatively, any of the other SAVT receivers shown and described in U.S. patent application Ser. Nos. 18/442,491, 18/821,542 and 18/921,989 (Docket Nos. HYFYP0015, HYFYP015X1 and HYFYP015X1X1) may be used instead of or in combination with the SAVT receiver of FIG. 17.

EM signal 529c (shown in FIG. 16) arrives at input terminal 621. A corresponding SAVT transmitter is implemented at IVI processor 60 in order to transmit to a display as shown in FIG. 16. This transmitter is implemented as is SAVT transmitter 410 as described above but with the following modifications. SAVT transmitter 410 inputs incoming serial video samples and distributes them amongst a plurality of input vectors in order to transmit analog video samples in parallel over a plurality of electromagnetic pathways 529a-529c each to an SAVT source driver 580a-580d. There may be a single EM pathway or multiple EM pathways and typically there may be six pathways for a standard display. If there are six pathways 529a-529c, N=960 (for a typical source driver IC), this means a total of 5760 samples per line of the display, 1920 RGB pixels. Twelve pathways may be used and would provide 3840 RGB pixels, sufficient for a 4K display (3840×2160 pixels) having 2160 rows or 6480 sub-pixels in one line. The values of N=960 and six pathways is suitable for the SAVT transmitter at the IVI processor transmitting to a display 584.

At each source driver 580a-580d the incoming analog EM signal is received at input terminal 621 and each analog sample in turn is distributed via sampling circuitry to a storage cell of a particular column driver using the inverse of the predetermined permutation used in the transmitter. Once all samples for that source driver are in place they are driven onto the display. As a result, the original stream of time-ordered video samples containing color and pixel-related information is conveyed from video source to video sink. The inverse permutation effectively stores the incoming samples as a row in the storage array (for display) in the same order that the row of samples was received at the distributor. It should be understood that any permutation scheme may be used by the distributor and, whichever permutation scheme that is used by the transmitter, its inverse will be used by control logic in each source driver in order to distribute the incoming samples to the column drivers.

In one embodiment, four control signals for every 60 video samples are inserted into the stream of samples in the distributor 502 to be sent to the source driver 580d. As shown, each input vector in the line buffer 506 includes a total of 1024 values, including the four control signals per every 60 video samples. The control signals may be inserted into various positions in an input vector, by way of example, “samples” 960-1023 of the input vectors 510-514 may actually be control signals. Any number of control signals in each input vector may be used. Further, an arbitrary but finite number of control signals is possible. The more control signals that are transmitted, the higher the data transmission rate needed. Ideally, the number of control signals is limited to what fits into the blanking periods so that there can be a correspondence between transmit rate and displayed lines (thus reducing the amount of storage required, or any additional re-synchronization). And further, the control signals may be inserted into the stream of samples at the distributor or insertion of control signals be performed in another location.

In one particular embodiment, each line buffer 506 or 508 has input ports for the incoming samples and the samples are clocked in at a frequency of FPIXEL; each line buffer also has six output ports, e.g., 511 or 521 (in the case where there are six EM signals, each being sent to one of six source drivers) and the samples are clocked out serially from each input vector at an SAVT frequency of FSAVT. It is also possible to clock in two R, two G and two B samples at a time instead of one each, or three at a time, etc. In one embodiment, FSAVT=663.552 MHz for 24 channels. A PLL (not shown) of each source driver multiplies the relatively slow reference clock 413 (e.g., FSAVT/64) from its source (e.g., TCON, SoC, MCU, recovered from GMSL, SAVT transmitter, in HDMI data, etc.), up to the full speed FSAVT clock (e.g., approximately 675 MHz) with 11 phases, selectable per clock cycle. There is also high-speed timing generation (not shown) in each source driver to generate sampling strobes, reset signals and output transfer strobes for the SHA amplifiers 0-15.

In the SAVT source driver 580d each distributer amplifier drives adjacent columns and all control signals are handled by a single amplifier. Shown is an input terminal 621 which de-multiplexes and distributes the incoming pixel data and control signals from the SAVT transmitter to S/H amplifiers 624 (inputting the pixel data numbered from 0 to 14) and to amplifier 626 which receives the control signals. The pixel data from amplifiers 624 is transferred to either storage array A 628 or to storage array B 630 as is described above and the control signal is handled by component 636 and output at 638. The pixel data from either storage array is then input into column drivers 622 and output onto the columns 634 as has been described above. Not shown is control logic for controlling the timing of the input amplifiers, storage arrays and column drivers. As the pixel data is received sequentially on a single channel (per chip), it is stored into the A/B collectors sequentially (one Fsavt cycle apart), although it is also possible to store 15 sub-pixels into the array in parallel from the 15 SHA amplifiers. S/H amplifiers 824 perform de-multiplexing (aka de-interleaving) and full de-multiplexing is not complete until the samples have been distributed to each of the columns. The A/B collectors also perform part of this task in that the collectors are sampled sequentially into separate rows (a de-multiplexing function) and then the columns are further processed.

Thus, 15 interleaved S/H amplifiers receive the incoming pixel data and each drives 64 columns which are adjacent, i.e., 64 video tracks, thereby minimizing the span of columns that are driven by each amplifier. This architecture provides 15 blocks of 64 video samples plus one sub-band channel (control signals) of 64 bits per display line (per source driver). For example, amplifier 0 drives columns 0-63, the second amplifier drives columns 64-127, etc., the 15th amplifier drives columns 896-959 and amplifier 626 drives the control signals. Having all control signals on one channel means no difference in amplitude, delays or other from one signal to the next (if they were on different channels). It is also possible that the control signals arrive on channel zero (i.e., amplifier 0) instead of amplifier 15; that is advantageous in that the control information arrives earlier than the pixel data. Another advantage of this architecture is that control signal extraction needs to look at only one de-interleaving amplifier output rather than be distributed across all amplifiers, simplifying synchronization. Of course, there may be fewer or greater than 15 S/H amplifiers depending upon the implementation.

In this figure there are 15 video amplifiers, each driving 64 subpixels=960 subpixels/chip. There is one channel devoted to control, carrying 64 symbols per line (per source driver). If we use MFM for timing synchronization, the 64 symbols will be transition encoded, and after accounting for flag and command bits, that will leave 24 or 25 control bits per line.

As shown, the control channel receives a control signal at amplifier 626 which is input to comparator 636 having a reference voltage of 0 V and operating at a 16th of FSAVT or approximately 41.5 MHz. Assuming that the control signals are in the range of −0.5 V up to +0.5 V, the comparator will detect if the control signal is greater than 0 V (meaning a digital 1) or if the control signal is less than 0 V (meaning a digital zero). This digital data is then output at 638 and thus provides a single control bit every 16 samples. Control signals provide synchronization and phase alignment. From an implementation perspective, the comparator may simply be a zero crossing detector, in which case a reference voltage is not required.

This particular embodiment is for a 4K 120 OLED display and example parameter values are shown in Table 1 below. One of skill in the art will find it straightforward to modify the architecture to suit other display sizes, resolutions and speeds.

TABLE 1
Example Values

| Parameter | Value | Units |
|---|---|---|
| Hpix | 3840 | Pixels |
| Vpix | 2160 | Pixels |
| Screen Refresh | 120 | Hz |
| RxChips | 1 | Chips/system |
| Hsubpix | 11520 | Subpixels/line |
| SubpixRate | 2.986 | GSamples/sec |
| SubpixelOverhead | 1.08× | =65/60 (synch. |
| | | and control |
| | | overhead) |
| SampleRate per chip | 3.22 | GSamples/sec |
| Ref. Clock Freq. (Fsavt/64) | 50,388,480 | Hz |
| Input Sampling Aperture(Tsavt) | 0.30 | ns |
| Scan Line Duration | 3.46 | us |

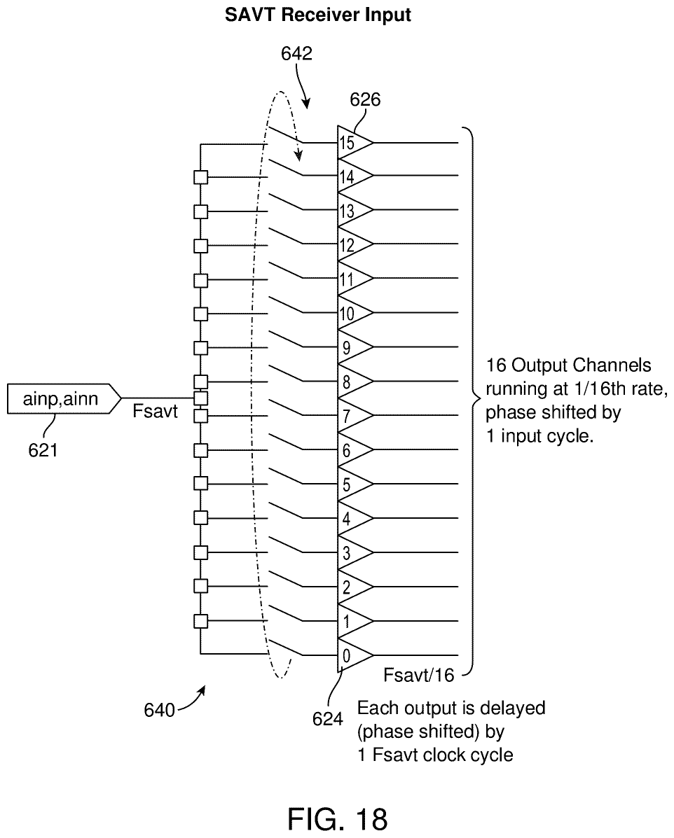

FIG. 18 illustrates a source driver input of source driver 580d for interleaving multiple input amplifiers which allows speed requirements to be met. (It is possible to use a single amplifier but transmission speed would be reduced.) Shown is the input terminal 621, distribution amplifiers 0-14 624 and amplifier 626 and an associated switch 642 which rotates in order to effectively connect one amplifier at a time to receive one of the incoming sub-pixels or control signal, as the case may be. Not shown are sampling capacitors on the inside of the switches, important to achieve the speed required, thus reducing the bandwidth requirements of the amplifiers themselves. Thus, the input is interleaved 16 ways and the outputs of the switch are de-multiplexed into 16 channels running at 1/16 the data rate. Each of the 960 sub-pixels in a line are conveniently grouped into 15 groups of 64 sub-pixels each and one channel is dedicated for detection of, and handling of, control signals.

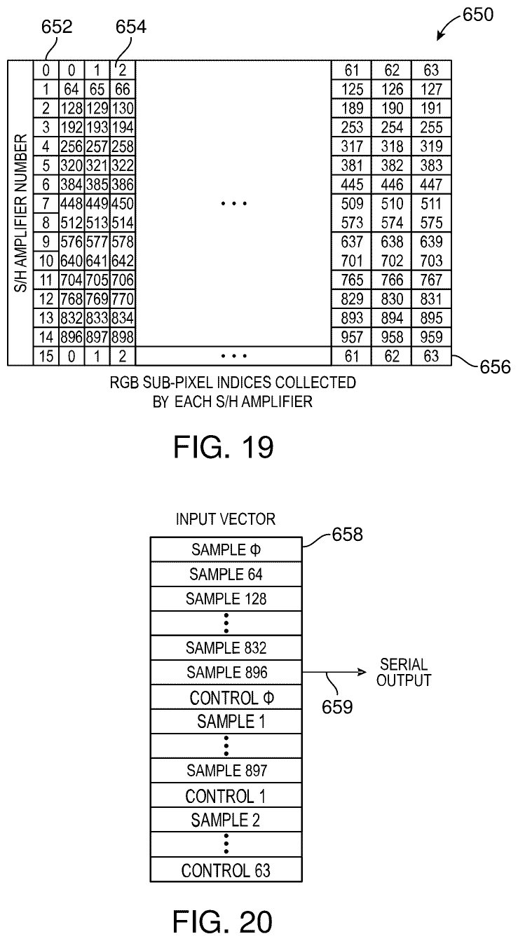

FIG. 19 is a summary of a pixel transmission order 650 showing how pixels 0-959 and control signals 0-63 are transmitted from the SAVT transmitter 410 to the source driver 580d and to which amplifier each is assigned. Shown is the natural order of sub-pixels as delivered via CEDS (clock-embedded differential signaling), for example, the sub-pixels arriving as read from left-to-right and then from top-to-bottom. Because of the 16-way interleaving of the input data at the source driver, the preferred method of transmitting the sub-pixels to the source driver is starting at the top left from top-to-bottom and then from left-to-right, i.e., the indices of the sub-pixels (and control signals) transmitted are 0, 64, 128, etc. Shown are indices for the S/H amplifiers 652, an example of a sub-pixel index 654 and control track 656 of the 16th amplifier.

In this permutation, 15 of the amplifiers (0-14) each drive 64 adjacent columns with sub-pixel values, while amplifier 15 handles all 64 of the control signals. This variation minimizes the hardware in the source driver and also minimizes the wiring load on the input amplifiers. Further, this variation allows for the slowest possible SAVT transmission rate as padding is not required in the data sequences. In order to best display text and other sharp transitions in intensity, it is preferable that the sampling amplifiers should be able to settle to a new value every 1/Fsavt, or approximately 1.5 ns per sample. In order to implement this architecture, the sequence of sub-pixel indices for transmission in a transmitter is: 0, 64, 128, . . . 832, 896; 1, 65, . . . 897; . . . ; 63, 127, 191, . . . 895, 959.

FIG. 20 is a block diagram of an input vector 658 of an SAVT transmitter having a predetermined permutation that provides for the sequence of sub-pixel transmission required by FIG. 19. As described earlier, as the sub-pixels arrive in the distributor from the timing controller they are distributed into input vector 658 in the order shown. When full, the samples in the input vector are then output serially via output port 659, converted if necessary, and then transmitted to a source driver 580. Not shown are other input vectors of the line buffer; each input vector will have a similar permutation and the other source drivers corresponding to each input vector will have the same architecture as 580d.

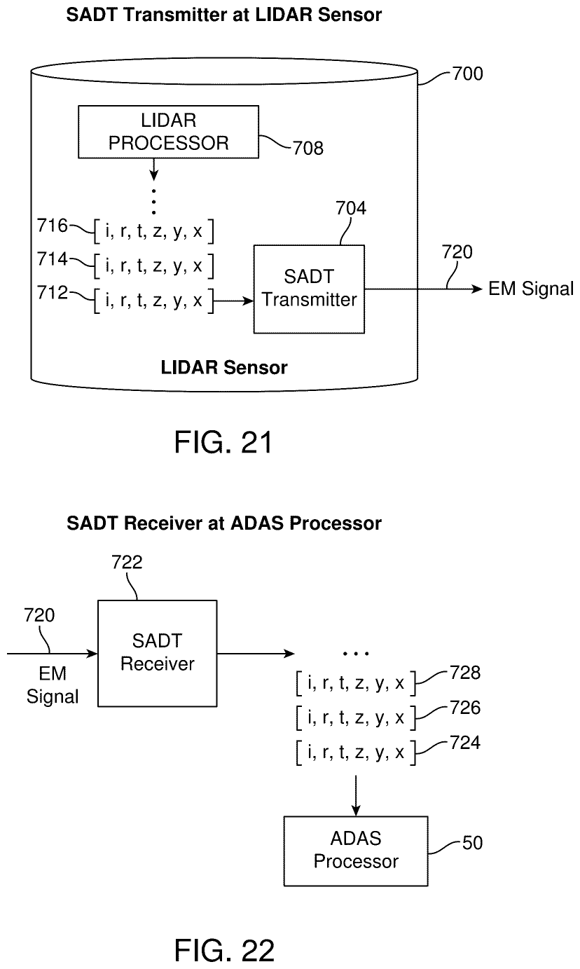

The sub-pixel ordering scheme shown in FIGS. 20 and 21 may be replaced or modified by any of the other sub-pixel ordering schemes disclosed in in U.S. patent application Ser. No. 18/442,491.

The above architecture of source driver 580d along with the above transmission order provides the advantages above and also retains the slowest possible SAVT clock rate. Accurate sampling of each sub-pixel within the time available may be provided by synchronization. As mentioned above, other permutations are possible. Another possible permutation (not shown) minimizes SAVT bandwidth requirements and thus uses a permutation whereby all the sub-pixels of the each color are transmitted as a group, with blanked transition bands between groups to lower the bandwidth between groups. By way of example, all of the red sub-pixels are first transmitted from the SAVT transmitter to the source driver 580d, followed by the green, then the blue sub-pixels.

### Sampled Analog Data Transport Between LiDAR Sensor and Processor

As mentioned above, one embodiment of the present invention uses sampled analog data transport (SADT) to transport LiDAR data from a LiDAR sensor to an ADAS processor of the vehicle. Similar to transport of video data, transport of LiDAR data makes use of a version of the SAVT transmitter of FIG. 14, albeit transmitting LiDAR data rather than video, hence the nomenclature SADT instead of SAVT.

FIG. 21 illustrates an SADT transmitter at a LiDAR sensor. As known in the art, a LiDAR sensor 700 in a vehicle emits laser pulses, measures the time it takes for those pulses to return after bouncing off nearby objects, processes that data, and then outputs resultant data to a processor of the vehicle. Typically, this output data will include point cloud data, namely the X, Y and Z coordinates representing the distances to objects or surfaces within its field of view, and optionally a timestamp (t) for each data point indicating when that data point was measured, reflectivity (r), and intensity (i). The timestamp allows the receiving processor to reconstruct more accurately the three-dimensional scene around the vehicle. Reflectivity is a measure of how much light or laser energy is reflected back from a particular point on an object or surface; higher reflectivity indicates surfaces that reflect more light. Intensity refers to the strength or magnitude of the returned laser pulse from a specific point; its value can vary based upon distance, material, and sensor settings.

As shown, processor 708 of the LiDAR sensor outputs a continuous stream of data values for each point in the point cloud; shown in order of their output are sets of data values 712, 714 and 716 representing three points in the point cloud. The order in which the data values are output from the processor 708 depends upon the scanning pattern and configuration of sensor 700; a variety of scanning patterns may be used. By way of example, the scanning pattern may be a 360° sweep in which the laser beam is swept in a full circle around the vehicle, changing the vertical angle as a sensor sweeps, thus capturing data at different heights. Or, a multilayer scanning pattern may be used in which multiple laser beams scan at varying angles in order to capture data at different heights simultaneously; or, any fixed a custom scanning pattern may be used depending upon the design of the LiDAR sensor and its particular application. No matter the scanning pattern, the particular order of output of the data values from processor 708 is also known a priori by any corresponding SADT receiver (or the ADAS processor) of LiDAR data (shown below) in order to properly organize and interpret that LiDAR data. Typically, the LiDAR sensor itself will convert the received laser reflections into digital data in order that the processor 708 can produce the 3-D coordinates, timestamp, reflectivity and intensity also in digital format.

Turning now to a discussion of the SADT transmitter 704, it is preferably implemented as is the SAVT transmitter of FIG. 14, except that instead of BG . . . RG . . . or RGB inputs, the inputs are sets of data values 712-716, etc. and DACs 526-528 will be present. Preferably, transmitter 704 outputs a single EM signal 720 (meaning only a single input vector is used) in order to minimize wiring, although it is certainly possible to include two or more output EM signals as shown in FIG. 14. SADT transmitter 704 inputs sets of data values 712-716 sequentially in the order shown, each particular data value being input serially into the transmitter, e.g., the data values 712 are input in the order x, y, z, t, r, i, and then distributed into the input vector or vectors of the distributor according to the permutation used. If the data values x, y, z, t, r, i, are presented to the transmitter 704 in parallel, they may also be distributed into the input vector or vectors using a particular permutation. Additional data values per data point may also be input per set of data values, and each input set may be limited to only the x, y and z coordinates. And, even though transmitter 704 is shown within the housing of the LiDAR sensor 700, it may be located external to LiDAR sensor 700.

As previously discussed with reference to FIG. 14, EM signal 720 thus represents the input LiDAR data values in a stream of analog levels transmitted over any suitable electromagnetic pathway such as wire, cable, optical fiber, wireless, etc. EM signal 720 is transmitted, for example, from a LiDAR sensor 700 through vehicle 10 to an intermediate processor 42 or directly to ADAS processor 50 where it is received at a corresponding SADT receiver.

FIG. 22 illustrates an SADT receiver at processor 50 of vehicle 10. EM signal 720 is received at SADT receiver 722 from the corresponding 7ADT transmitter of FIG. 21. SADT receiver 722 is preferably implemented as is SAVT receiver 420 of FIG. 15 except that its outputs will not be BG . . . RG . . . values, but rather data values 724-728, etc. as shown and the ADC 566 will be present. Sets of data values 724-728 are output serially or in parallel in the order shown, i.e. output set 724 corresponds to input set 712, etc. As shown, only a single EM signal 720 is input into the receiver, meaning that there will be an output vector, although if transmitter 704 outputs numerous EM signals, there will be a corresponding number of input EM signals at receiver 722. Further, receiver 722 is aware of the permutation used by transmitter 704 and is able to output data values 724-728 in the order in which they were input. As the collector 540 holds each output vector or vectors, the data values in a particular set may be read out from that output vector in parallel or serially, depending upon the needs of processor 50. And, even though receiver 722 is shown external to processor 50 it may be located within an ADAS system, on the same board or same chip as processor 50.

### Sampled Analog Data Transport Between Radar Sensor and Processor

As mentioned above, one embodiment of the present invention uses sampled analog data transport (SADT) to transport radar data from a radar sensor to an ADAS processor of the vehicle. Similar to transport of video data, transport of radar data makes use of a version of the SAVT transmitter of FIG. 14, albeit transmitting signals representing radar data rather than video, hence the nomenclature SADT instead of SAVT.

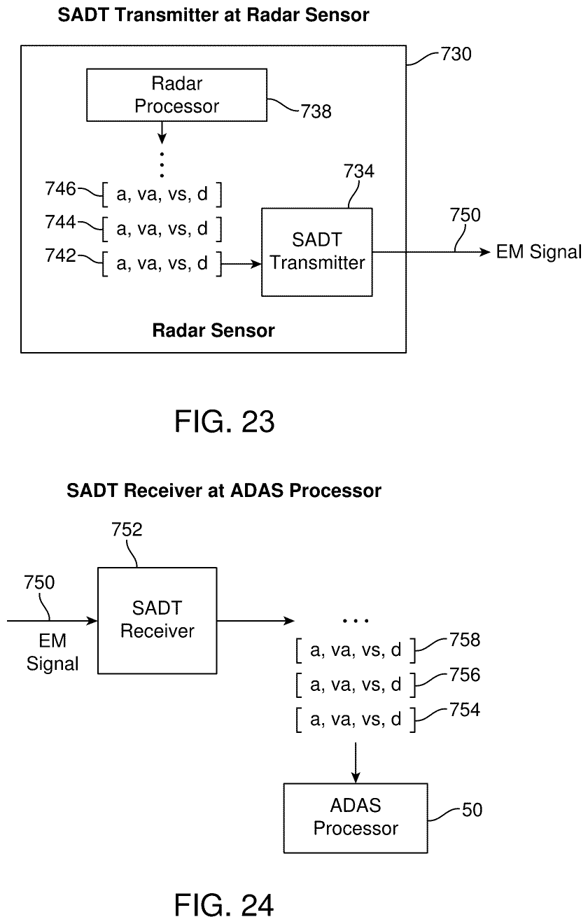

FIG. 23 illustrates an SADT transmitter at a radar sensor. As known in the art, a radar sensor 730 in a vehicle emits radio waves and receives their reflections (the raw radar echoes) in order to detect and track objects in the vicinity of the vehicle. The raw radar echoes are processed internally at a processor 738 that then outputs resultant data to a processor of the vehicle. Typically, for each object detected, this output data will include: a distance measurement (d) indicating how far the object is from the vehicle; the relative velocity of that object which includes a magnitude indicating the speed (vs) of the object relative to the vehicle, and an angle (va) indicating the object's direction relative to the orientation of the radar sensor; and an azimuth angle (a) which gives the position of the detected object relative to the vehicle. Other data may be provided and may include an elevation angle indicating the vertical angle at which an object is detected, and an object classification which may include an estimate as to the size, shape and particular movements of the object. For a radar sensor mounted at the front of the vehicle and facing directly forward, it is possible that the data may only include the distance to the object.

As shown, processor 738 of the radar sensor outputs a continuous stream of sets of data values for the objects detected; shown in order of their output are sets of data values 742, 744 and 746 representing three sets of data. These sets of data values may represent a single object which is being tracked continuously, multiple objects which are being tracked, or a mixture of both.

The order in which the data values are output from the processor 738 depends upon the design and particular scanning method used by the radar sensor; two primary scanning methods are used. In continuous wave radar (CWR) the sensor continuously emits radio waves and the sensor antenna scans using a conical scan (continuously sweeping the field of view and reporting objects detected at different azimuth angles in sequence) or electronic scanning (allowing for a more flexible scanning pattern). Or, frequency modulated continuous wave (FMCW) radar is used and the scanning pattern may include sweeping frequency (objects detected at different distances are reported sequentially) or multiple beams (writing data on multiple objects at once). No matter the scanning pattern used, the particular order of output of the sets of data values from processor 738 (and the scanning pattern) is also known a priori by any corresponding SADT receiver (or the ADAS processor) of radar data (shown below) in order to properly organize and interpret that radar data. In addition, even if the scanning pattern is not known by the receiver, the distance and azimuth angle data tells the receiver where the object is. Typically, the radar sensor itself will convert the received raw radar data into digital data in order that the processor 738 can produce the distance, velocity and azimuth angle data.

Turning now to a discussion of the SADT transmitter 734, it is preferably implemented as is the SAVT transmitter of FIG. 14, except that instead of BG . . . RG . . . or RGB inputs, the inputs are sets of data values 742-746, etc. and DACs 526-528 will be present. Preferably, transmitter 734 outputs a single EM signal 750 (meaning only a single input vector is used) in order to minimize wiring, although it is certainly possible to include two or more output EM signals as shown in FIG. 14. SADT transmitter 734 inputs sets of data values 742-746 sequentially in the order shown, each particular data value being input serially into the transmitter, e.g., the data values 742 are input in the order d, vs, va, a, and then distributed into the input vector or vectors of the distributor according to the permutation used. If the data values d, vs, va, a, are presented to the transmitter 734 in parallel, they may also be distributed into the input vector or vectors using a particular permutation. Additional data values per data point may also be input per set of data values, and each input set may be limited to only the distance measurement. And, even though transmitter 734 is shown within the housing of the radar sensor 730, it may be located external to radar sensor 730.

As previously discussed with reference to FIG. 14, EM signal 750 thus represents the input radar data values in a stream of analog levels transmitted over any suitable electromagnetic pathway such as wire, cable, optical fiber, wireless, etc. EM signal 750 is transmitted, for example, from a radar sensor 730 through vehicle 10 to an intermediate processor 42 or directly to ADAS processor 50 where it is received at a corresponding SADT receiver.

FIG. 24 illustrates an SADT receiver at processor 50 of vehicle 10. EM signal 750 is received at SADT receiver 752 from the corresponding SADT transmitter of FIG. 23. SADT receiver 752 is preferably implemented as is SAVT receiver 420 of FIG. 15 except that its outputs will not be BG . . . RG . . . values, but rather sets of data values 754-758 as shown and the ADC 566 will be present. Sets of data values 754-758 are output serially or in parallel in the order shown, i.e. set 754 corresponds to set 742, etc. As shown, only a single EM signal 750 is input into the receiver, meaning that there will be a single output vector, although if transmitter 734 outputs numerous EM signals, there will be a corresponding number of input EM signals at receiver 752. Further, receiver 752 is aware of the permutation used by transmitter 734 and is able to output sets of data values 754-758, etc. in the order in which they were input. As collector 540 holds each output vector or vectors, the data values in a particular set may be read out from that output vector in parallel or serially, depending upon the needs of processor 50. And, even though receiver 752 is shown external to processor 50 it may be located within an ADAS system, on the same board or same chip as processor 50.

### Sampled Analog Data Transport Between Ultrasonic Sensor and Processor

As mentioned above, one embodiment of the present invention uses sampled analog data transport (SADT) to transport ultrasonic data from an ultrasonic sensor to an ADAS processor of the vehicle. Similar to transport of video data, transport of ultrasonic data makes use of a version of the SAVT transmitter of FIG. 14, albeit transmitting signals representing ultrasonic data rather than video, hence the nomenclature SADT instead of SAVT.

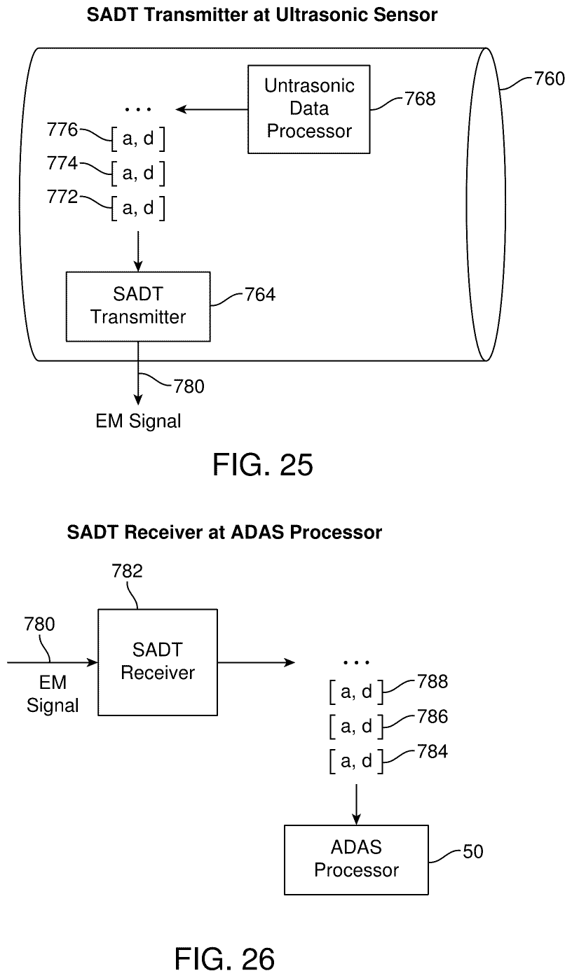

FIG. 25 illustrates an SADT transmitter at an ultrasonic sensor. As known in the art, an ultrasonic sensor 760 in a vehicle emits high-frequency sound waves and receives their reflections in order to detect and track objects in the vicinity of the vehicle. The raw ultrasonic data (including the measured time to receive reflections) is processed internally at a processor 768 that then outputs resultant data to a processor of the vehicle. Typically, for each object detected, this output data may include: a distance measurement (d) indicating how close the object is to the vehicle; an angle (a) indicating the object's direction relative to the orientation of the sensor; and signal strength, indicating the surface characteristics of the detected object. Other data may be provided and may include whether or not an object is detected within the sensor's range, the number of objects detected within its range in the raw ultrasonic data (the actual ultrasonic echoes and waveforms received by the sensor). For an ultrasonic sensor mounted on the vehicle and having a known orientation with respect to the vehicle (e.g. facing directly outward), it is possible that the data may only include the distance to the object. As shown, processor 768 of the ultrasonic sensor outputs a continuous stream of sets of data values for the object or objects detected; shown in order of their output are sets of data values 772, 774 and 776 representing three sets of data. These data values may represent a single object which is being tracked continuously, multiple objects which are being tracked, or a mixture of both.

The order in which the data values are output from the processor 768 typically depends upon the order in which the sound waves are emitted, e.g. the first sound wave emitted results in data values set 772, the second wave results in data values set 774, etc. No matter the order used, the particular order of output of the data values from processor 768 is also known a priori by any corresponding SADT receiver (or the ADAS processor) of ultrasonic data (shown below) in order to properly organize and interpret that ultrasonic data. In addition, even if the order is not known by the receiver, the distance data tells the receiver where the object is in relation to the sensor. Typically, the ultrasonic sensor itself will convert the received raw ultrasonic data into digital data in order that the processor 768 can produce the distance and angle data.

Turning now to a discussion of the SADT transmitter 764, it is preferably implemented as is the SAVT transmitter of FIG. 14, except that instead of RG . . . BG . . . or RGB inputs, the inputs are sets of data values 772-776, etc. and DACs 526-528 will be present. Preferably, transmitter 764 outputs a single EM signal 780 (meaning only a single input vector is used) in order to minimize wiring, although it is certainly possible to include two or more output EM signals as shown in FIG. 14. SADT transmitter 764 inputs data values 772-776, etc. sequentially in the order shown, each particular data value being input serially into the transmitter, e.g., the data values 772 are input in the order d, a, and then distributed into the input vector or vectors of the distributor according to the permutation used. If the data values d, a, are presented to the transmitter 764 in parallel, they may also be distributed into the input vector or vectors using a particular permutation. Additional data values per object may also be input per set of data values, and each input set may be limited to only the distance measurement. And, even though transmitter 764 is shown within the housing of the ultrasonic sensor 760, it may be located external to ultrasonic sensor 760.

As previously discussed with reference to FIG. 14, EM signal 780 thus represents the input ultrasonic data values in a stream of analog levels transmitted over any suitable electromagnetic pathway such as wire, cable, optical fiber, wireless, etc. EM signal 780 is transmitted, for example, from an ultrasonic sensor 760 through vehicle 10 to an intermediate processor 42 or directly to ADAS processor 50 where it is received at a corresponding SADT receiver.

FIG. 26 illustrates an SADT receiver at processor 50 of vehicle 10. EM signal 780 is received at SADT receiver 782 from the corresponding SADT transmitter of FIG. 25. SADT receiver 782 is preferably implemented as is SAVT receiver 420 of FIG. 15 except that its outputs will not be BG . . . RG . . . values, but rather sets of data values 784-388, etc. as shown and the ADC 566 will be present. Sets of data values 784-388 are output serially or in parallel in the order shown, i.e. output set 784 corresponds to input set 772, etc. As shown, only a single EM signal 780 is input into the receiver, meaning that there will be a single output vector, although if transmitter 764 outputs numerous EM signals, there will be a corresponding number of input EM signals at receiver 782. Further, receiver 782 is aware of the permutation used by transmitter 764 and is able to output data values 784-788, etc. in the order in which they were input. As collector 540 holds each output vector or vectors, the data values in a particular set may be read out from that output vector in parallel or serially, depending upon the needs of processor 50. And, even though receiver 782 is shown external to processor 50 it may be located within an ADAS system, on the same board or same chip as processor 50.

### SSVT or SSDT Signal, Encoding and Decoding

As mentioned above, various embodiments of the present invention disclose that an SSVT signal may be used to transport video, and that an SSDT signal may be used to transport LiDAR, radar or ultrasonic data within, to, or from a vehicle. This section provides more detail on SSVT, although the details also apply to SSDT.

For the purposes of this disclosure, an electromagnetic signal (EM signal) is a variable represented as electromagnetic energy whose amplitude changes over time. EM signals propagate through EM paths, such as a wire pair (or cable), free space (or wireless) and optical or waveguide (fiber), from a transmitter terminal to a receiver terminal. EM signals can be characterized as continuous or discrete independently in each of two dimensions, time and amplitude. “Pure analog” signals are continuous-time, continuous-amplitude EM signals; “digital” signals are discrete-time, discrete-amplitude EM signals; and “sampled analog” signals are discrete-time, continuous-amplitude EM signals. One embodiment of the present disclosure discloses a novel discrete-time, continuous-amplitude EM signal termed a “spread-spectrum video transport” (SSVT) signal that is an improvement over existing SSDS-CDMA signals. SSVT refers to the transmission of electromagnetic signals over an EM pathway or pathways using an improved spread-spectrum direct sequence (SSDS)-based modulation.

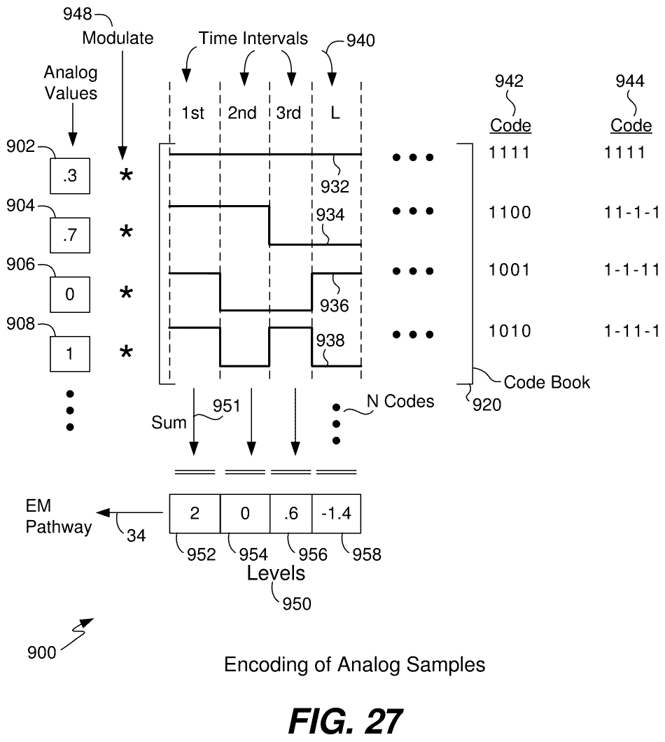

FIG. 27 illustrates a simplistic example showing how signal samples, in this case, analog values, are encoded within an encoder and then sent over an electromagnetic pathway. Shown is an input vector of N analog values 902-908 which represent voltages of individual pixels within a video frame. These voltages may represent luminosity of a black-and-white image or luminosity of a particular color value in a pixel, e.g., an R, G or B color value of the pixel, i.e., each value represents a sensed or measured amount of light in the designated color space. Although pixel voltages are used in this example, this encoding technique may be used with voltages representing any of a variety of signals from a sensor such LiDAR values, radar values, ultrasonic values, sound values, haptic values, aerosol values, etc., and the analog values may represent other samples such as current, etc. Signal samples that are digital values may also be encoded and this digital encoding is explained below. Further, even though one encoder and one EM pathway is shown, an embodiment of the invention works well with multiple encoders, each transmitting over an EM pathway.

The range of these voltages may be from 0 to 1 V for efficiency, although a different range is possible. These voltages typically are taken from pixels in a row of a frame in a particular order, but another convention may be used to select and order these pixels. Whichever convention is used to select these pixels and to order them for encoding, that same convention will be used at the receiving end by the decoder in order to decode these voltages in the same order and then to place them in the resulting frame where they belong. By the same token, if the frame is in color and uses RGB, the convention in this encoder may be that all of the R pixel voltages are encoded first, and then the G and B voltages, or the convention may be that voltages 902-906 are the RGB values of a pixel in that row and that the next three voltages 908-912 represent the RGB values of the next pixel, etc. Again, the same convention used by this encoder to order and encode voltages will be used by the decoder at the receiving end. Any particular convention for ordering analog values 902-908 (whether by color value, by row, etc.) may be used as long as the decoder uses the same convention. As shown, any number of N analog values 902-908 may be presented for encoding at a time using code book 920, limited only by the number of entries in the code book.

As mentioned, code book 920 has any number of N codes 932-938; in this simple example, the code book has four codes meaning that four analog values 902-908 are encoded at a time. A greater number of codes such as 127 codes, 255 codes, etc., may be used, but due to practical considerations such as circuit complexity, fewer codes are preferably used. As known in the art, code book 920 includes N mutually-orthogonal codes each of length L; in this example L=4. Typically, each code is an SSDS code but need not necessarily be a spreading code as discussed herein. As shown, each code is divided into L time intervals (also called “chips”) and each time interval includes a binary value for that code. As shown at code representation 942, code 934 may be represented in the traditional binary form “1100”, although that same code may also be represented as “1 1 −1 −1” as shown in code representation 944 for ease-of-use in modulating the value as will be explained below. Codes 932 and 936-938 may also be represented as in 942 or in 944. Note that each code of length L is not associated with a different computing device (such as a telephone), a different person or a different transmitter, as is done in CDMA.

Therefore, in order to send the four analog values 902-908 over a transmission medium 34 to a receiver (with a corresponding decoder) the following technique is used. Each analog value will be modulated by each chip in the representation 944 of its corresponding code; e.g., value 902, namely 0.3, is modulated 948 by each chip in the representation 944 of code 932 sequentially in time. Modulation 948 may be the multiplication operator. Thus, modulating 0.3 by code 932 results in the series “0.3, 0.3, 0.3, 0.3”. Modulating 0.7 by code 934 becomes “0.7, 0.7, −0.7, −0.7”; value “0” becomes “0, 0, 0, 0”; and “value “1” becomes “1, −1, 1, −1”. Typically, the first chip of each code modulates its corresponding analog value, and then the next chip of each code modulates its analog value, although an implementation may also modulate a particular analog value by all the chips of its code before moving on to the next analog value.

Each time interval, the modulated analog values are then summed at 951 (perceived vertically in this drawing) to obtain analog output levels 952-958; e.g., the summation of modulated values for these time intervals results in output levels of 2, 0, 0.6, −1.4. These analog output levels 952-958 may be further normalized or amplified to align with a transmission line's voltage restrictions and may then be sent sequentially in time as they are produced over an electromagnetic pathway (such as a differential twisted-pair) of transmission medium 34 in that order. A receiver then receives those output levels 952-958 in that order and then decodes them using the same code book 920 using the reverse of the encoding scheme shown here. The resultant pixel voltages 902-908 may then be displayed in a frame of a display at the receiving end in accordance with the convention used. Thus, analog values 902-908 are effectively encoded synchronously and sent over a single electromagnetic pathway in a sequential series of L analog output levels 952-958. Numerous encoders and electromagnetic pathways may also be used as shown and described herein. Further, the number of N samples that can be encoded in this manner depends upon the number of orthogonal codes used in the code book.

Advantageously, even though the use of robust SSDS techniques (such as spreading codes) results in a significant drop in bandwidth, the use of mutually-orthogonal codes, the modulation of each sample by chips of its corresponding code, summation, and the transmission of N samples in parallel using L output levels results in a significant bandwidth gain. In contrast with traditional CDMA techniques in which binary digits are encoded serially and then summed, the present invention first modulates the entire sample (i.e., the entire analog or digital value, not a single bit) by each chip in a corresponding code, and then sums those modulations at each time interval of the codes to obtain a resultant analog voltage level for each particular time interval, thus exploiting the amplitude of the resultant waveform. It is these analog output levels that are sent over a transmission medium, not representations of binary digits. Further, compression is not required for the transport of the sample values.

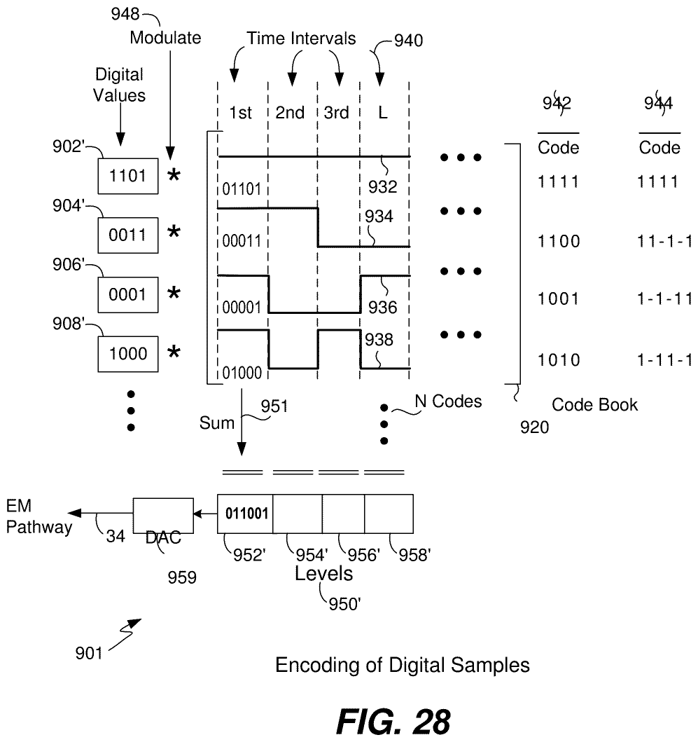

FIG. 28 illustrates this novel encoding technique as being applicable to signal samples that are digital values. Here, digital values 902′-908′ are digital representations of voltages. Using a different example of voltages, value 902′ is “1101” value 904′ is “0011,” value 906′ is “0001,” and value 908′ is “1000.” Each digital value is modulated (digitally multiplied) by the representation 944 of each code, that is by “1” or by “−1” depending upon the chip of the code corresponding to the digital value to be modulated. Considering only the first time interval 940 of each code, and adding a most significant bit (MSB) which is the sign bit, modulating “1101” yields “01101” (the MSB “0” meaning a positive value), modulating “0011” yields “00011”, modulating “0001” yields “00001,” and modulating “1000” yields “01000.” These modulated values are shown annotated on the first time interval. (Although not shown, modulating by a −1 chip yields a negative value which may be expressed in binary using a suitable binary representation for negative values.)

Summing digitally, these modulated values in the first time interval yields digital value 952′ “011001” (again, the MSB is the sign bit); the other digital values 954′-958′ are not shown in this example, but are calculated in the same way. Considering this summation in base 10, one can verify that the modulated values 13, 3, 1 and 8 do sum to 25. Although not shown in this example, typically additional MSBs will be available for the resultant levels 952′-958′ in that the sum may require more than five bits. For example, if values 902′-908′ are represented using four bits, then levels 952′-958′ may be represented using up to ten bits, in the case where there are 64 codes (adding log 2 of 64 bits). Or, if 32 modulated values are summed then five more bits will be added. The number of bits needed for the output levels will depend upon the number of codes.

The output levels 950′ may be first normalized to adjust to the DAC's input requirements and then fed sequentially into a DAC 959 for conversion of each digital value into its corresponding analog value for transmission over the EM pathway. DAC 959 may be a MAX5857 RF DAC (includes a clock multiplying PLL/VCO and a 14-bit RF DAC core, and the complex path may be bypassed to access the RF DAC core directly) and may be followed by a bandpass filter and then a variable gain amplifier (VGA), not shown. In some situations, the number of bits used in levels 950′ are greater than the number allowed by DAC 959, e.g., level 952′ is represented by ten bits but DAC 959 is an 8-bit DAC. In these situations, the appropriate number of LSBs are discarded and the remaining MSBs are processed by the DAC, with no loss in the visual quality of the resultant image at the display.

Advantageously, entire digital values are modulated, and then these entire modulated digital values are summed digitally to produce a digital output level for conversion and transmission. This technique is different from CDMA which modulates each binary digit of a digital value and then sums these modulated bits to produce outputs. For example, assuming that there are B bits in each digital value, with CDMA, there will be a total of B*L output levels to send, whereas with this novel digital (or analog) encoding technique there will only be a total of L output levels to send, thus having an advantage.

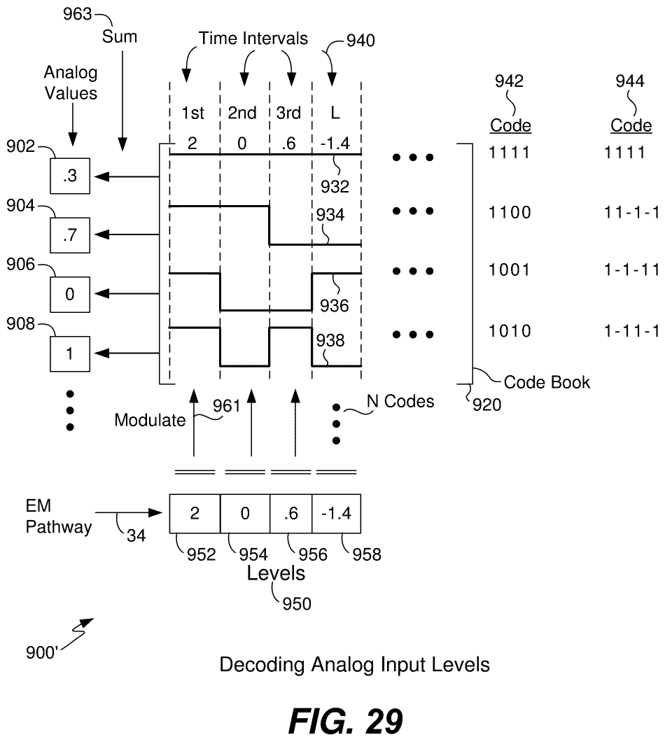

FIG. 29 illustrates the decoding of analog input levels that were encoded using the analog encoder above. As shown, L input levels 950 have been received over a single electromagnetic pathway of a transmission medium 34. As described herein and noted earlier, code book 920 includes N orthogonal codes 932-938 that will be used to decode input levels 950 to produce an output vector of N analog values 902-908, i.e., the same analog values 902-908 that were encoded above. To perform decoding, as indicated by the vertical arrows, each input level 952-958 is modulated 961 by each chip of each code corresponding to a particular index in the output vector 902-908. Considering modulation of levels 952-958 by the first code 932, such modulation produces the series of modulated values “2, 0, 0.6, −1.4”. Modulation of levels 952-958 by the second code 934 produces the series of modulated values “2, 0, −0.6, 1.4”. Modulation by the third code 936 produces “2, 0, −0.6, −1.4”, and modulation by the fourth code 938 produces “2, 0, 0.6, 1.4”.

Next, as indicated by the horizontal arrows, each series of modulated values is summed in order to produce one of the analog values 902-908. For example, the first series is summed to produce the analog value “1.2” (which becomes “0.3” after being normalized using the scale factor of “4). In a similar fashion, the other three series of modulated values are summed to produce the analog values “2.8”, “0” and “4”, and after being normalized yield the output vector of analog values 902-908. Each code may modulate the input levels and then that series may be summed, or, all may modulate the input levels before each series is summed. Thus, the output vector of N analog values 902-908 has been transported in parallel using L output levels.

Not shown in these examples is an example of decoding digital input levels, although one of skill in the art will find it straightforward to perform such decoding upon reading the encoding of digital values in the above description.

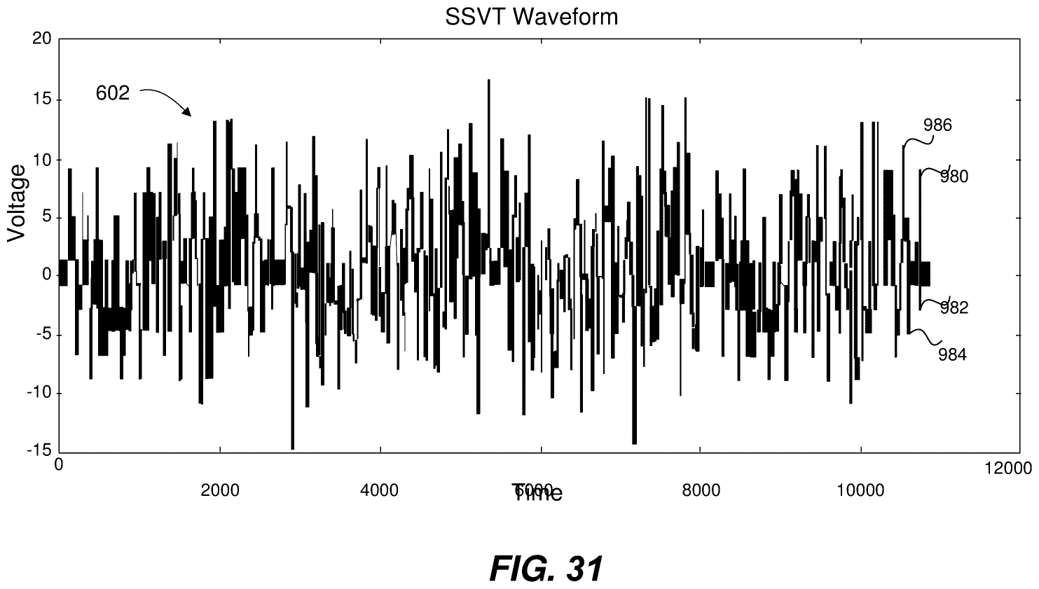

FIGS. 31A, 31B and 31C illustrate that the encoders and decoders may operate upon either analog samples or digital samples; the various analog and digital encoders and decoders have previously been described above. As explained above, there may be more than one EM pathway and accordingly more than one encoder/decoder pair and a corresponding number of DACs or ADCs as the case may be.

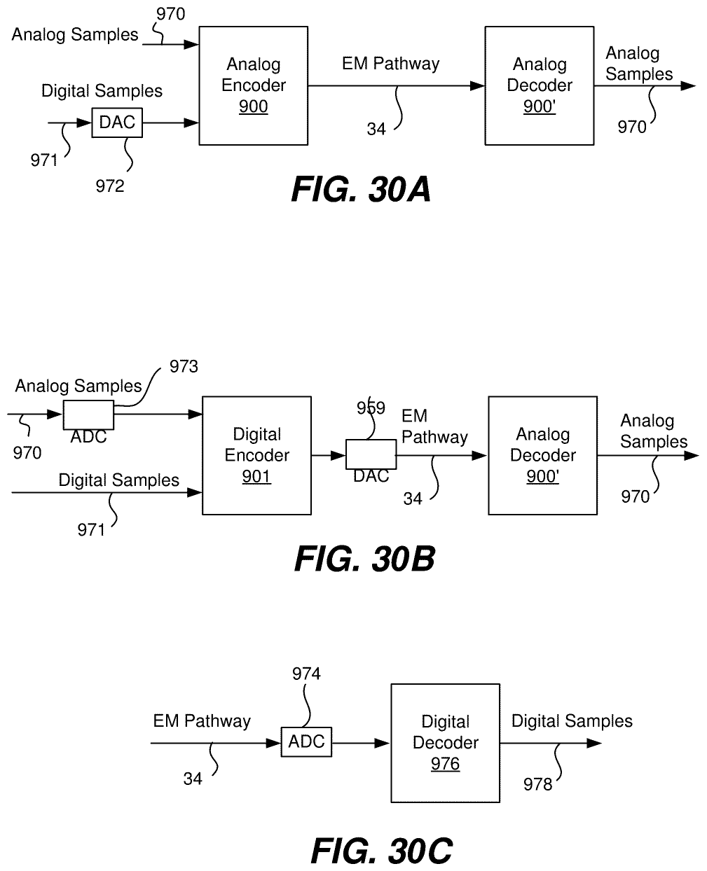

FIG. 30A illustrates use of an analog encoder and a corresponding analog decoder. Input into analog encoder 900 are either analog samples 970 or digital samples 971 that have been converted into analog by a DAC 972 located at the analog encoder. In this fashion, either analog or digital samples that arrive at the analog encoder may be encoded for transmission over an electromagnetic pathway on transmission medium 34. Analog decoder 900′ decodes the encoded analog samples to produce analog samples 970 for output. Analog samples 970 may be used as is or may be converted into digital samples using an ADC (not shown).

FIG. 30B illustrates use of a digital encoder and a corresponding analog decoder. Input into digital encoder 901 are either digital samples 971 or analog samples 970 that have been converted into digital by an ADC 973 located at the digital encoder. As the encoder is digital, a DAC 959 located at the encoder converts the encoded samples into analog before transmission over the electromagnetic pathway. In this fashion, either analog or digital samples that arrive at the digital encoder may be encoded for transmission over an electromagnetic pathway on transmission medium 34. Analog decoder 900′ decodes the encoded analog samples to produce analog samples 970 for output. Analog samples 970 may be used as is or may be converted into digital samples using an ADC (not shown).

FIG. 30C illustrates use of a digital decoder to decode encoded analog signals that have arrived over an electromagnetic pathway on transmission medium 34. The encoded analog signals may been transmitted using either the analog encoder or the digital encoder described immediately above. An ADC 974 located at digital decoder 976 receives the encoded analog samples sent via the electromagnetic pathway and converts the samples into digital. These encoded digital samples are then decoded by digital decoder 976 into digital samples 978 (corresponding to the values of an input vector of samples that was originally encoded before transmission over the electromagnetic pathway). Digital samples 978 may be used as is or may be converted into analog samples using a DAC.

FIG. 31 shows a simulation (similar to an idealized oscilloscope trace) of an SSVT waveform 602 sent via an electromagnetic pathway after being output from an analog encoder (or after being digitally encoded and then converted by a DAC). The vertical scale is voltage, and the horizontal scale is a 100 ps oscilloscope measurement time interval. Note that SSVT signal 602 is an analog waveform rather than a digital signal (i.e., the signal does not represent binary digits) and in this embodiment can transport a range of voltages from about −15 V up to about +15 V. The voltage values of the analog waveform are (or at least can be) fully analog. Also, voltages are not limited to some maximum value, although high values are impractical.

As previously explained, analog voltage levels are sent sequentially over an electromagnetic pathway, each level being the summation of modulated samples per time interval, such as the analog output levels 952-958 above or the digital output levels 952′-958′ above (after being passed through a DAC). When sent, these output levels then appear as a waveform such as waveform 602. In particular, voltage level 980 represents the summation in a particular time interval of modulated samples (i.e., an output level). Using a simplistic example, sequential voltage levels 980-986 represent the transmission of four output levels. In this example, 32 codes are used, meaning that 32 samples may be transmitted in parallel; thus, voltage levels 980-986 (followed by a number of subsequent voltage levels, depending upon the number of chips in a code, L) form the transmission in parallel of 32 encoded samples (such as pixel voltages from a video source). Subsequent to that transmission, the next set of L voltage levels of waveform 602 represent the transmission of the next 32 samples. In general, waveform 602 represents the encoding of analog or digital values into analog output levels, and the transmission of those levels in discrete time intervals to form a composite analog waveform.

Due to such phenomena as attenuation, reflections due to impedance mismatches, and impinging aggressor signals, every electromagnetic pathway degrades electromagnetic signals that propagate through it, and thus measurements taken of input levels at a receiving terminal are always subject to error with respect to corresponding output levels made available at the transmitting terminal. Hence, scaling of input levels at a receiver (or normalization or amplification of output levels at a transmitter) may be performed to compensate, as is known in the art. Further, due to process gain (i.e., due to an increase in L which also increases electrical resilience) decoded input levels at a decoder are normalized by a scale factor using the code length to recover the transmitted output levels as is known in the art. Further, as herein described, although it is preferable that L>=N>=2, in some situations it is possible that L will be less than N, i.e., N>L>=2.

### Combined Video or Data Transport Embodiment

As discussed immediately above, the input vector of N samples 902-908 shown in FIG. 27 (for example) may represent samples from a single video camera, LiDAR, radar or ultrasonic sensor, and may be encoded and decoded using SSVT or SSDT (as the case may be), thus producing an output vector of the same analog samples 902-908 shown in FIG. 29 (for example). In a variation of this embodiment, each of the locations 902-908 in the input vector may represent a data stream from a different video camera, a LiDAR sensor, a radar and sensor or an ultrasonic sensor.

Using a simple example, referring to FIG. 3 and FIG. 27, and assuming N equals four, there are four video cameras on the vehicle that each input a data stream of video samples into an SSVT transmitter 110 (more precisely, into its distributor 204), each data stream being distributed into one of the locations of the input vector by distributor 204. Thus, the video samples of the video stream from the first video camera are distributed continuously as they arrive into location 902 of the input vector (the first video sample having a value of “0.3”), the video samples from the second video camera being distributed into location 904, the video samples from the third video camera being distributed into location 906, and the video samples from the third camera distributed into location 908. As described herein, once the input vector is filled it is encoded and the EM signal is transmitted over a single EM pathway to an SSVT receiver where it is decoded to produce the analog samples 902-908 of the output vector of FIG. 29, this process occurring continuously as video samples are received at the transmitter. Accordingly, location 902 of the output vector represents video samples from first video camera, location 904 represents samples from the second video camera, location 906 represents samples from the third video camera, and location 908 represent samples from the fourth video camera. As described above in FIG. 4, the SSVT receiver 120 collects the incoming samples from the output vector and then outputs four data streams, each data stream corresponding to one of the four video cameras on the vehicle. In this manner, any number of streams from different video cameras may be combined and sent over a single EM pathway within the vehicle. Of course, as shown and described above with reference to FIGS. 3 and 4, there may be any number of P electromagnetic pathways and EM signals connecting the transmitter to the receiver.

In another example, instead of combining any number of data streams from different video cameras to be sent over a single EM pathway, any number of data streams from different LiDAR sensors may be combined as described above and sent over an EM pathway. In another example, any number of data streams from different radar sensors may be combined as described above and sent over an EM pathway. In another example, any number of data streams from different ultrasonic sensors may be combined as described above an sent over an EM pathway. As described herein, the transmitter and receiver are SSDT transmitters and receivers as described and shown above using similar techniques for encoding and decoding as described above with respect to the SSVT transmitter and SSVT receiver of FIGS. 3 and 4.

In a variation on the above embodiments for combining like signals from like sensors, any of the video, LiDAR, radar or ultrasonic data streams coming from its corresponding sensor, may be combined with any of the other data streams. By way of example, referring again to FIGS. 3 and 28, video and data streams from a video camera, a LiDAR sensor, a radar sensor and an ultrasonic sensor may be input to the distributor of SSVT transmitter 110 and then distributed into locations in the input vector. Accordingly, location 902 holds the incoming data stream from the video camera, location 904 holds the incoming data stream for the LiDAR sensor, location 906 is the stream for the radar sensor, and 908 is for the ultrasonic sensor. Thus, at the output vector of the receiver shown in FIG. 29, location 902 outputs the video stream from the video camera, location 904 outputs data from the LiDAR sensor, location 906 outputs the radar data and location 908 outputs the ultrasonic data. In this fashion, incoming video or data streams from any number of different sensors may be input to a single SSVT (or SSDT, as the case may be) transmitter in order to transmit combined data to a receiver over a single EM pathway (or multiple, if desired) in order to recover those different video data streams at the receiver. Of course, any combination, permutation or number of input video and data sources may be used. For example, the transmitter may accept input from two video cameras and from two LiDAR sensors, or from four video cameras and from four radar sensors, or from eight LiDAR sensors, two radar sensors and two ultrasonic sensors, etc.

In addition, the input from a particular video camera or other data sensor need not only be assigned to a single location in the input vector. For example, assuming N equals 16 and that there are four video cameras, each video camera may be assigned to four locations in the input vector, thus locations 902-908 are assigned to video samples from the first video camera, the next four locations to the second video camera, etc. As these inputs, assignments and locations are known apriori, the corresponding receiver will know ahead of time which samples are in which locations of the output vector and will be able to reconstruct the video or data stream as the case may be in order to output the corresponding video or data streams that were input at the transmitter.

In an additional embodiment, even though an entire input vector representing video or data samples from any number or combination of video or other data sensors is encoded and transmitted as levels 950 as shown arriving at the receiver in FIG. 29, it is not necessary for the receiver to decode each and every location of the output vector in order to recover all of the input video and data streams. For example, assuming that data streams from four video cameras are input into an SSVT transmitter and that the input vector of FIG. 27 has a length of N=4, location 902 corresponding to the first video camera, 904 corresponding to the second video camera, etc., it is possible and may be desirable to only decode the data stream corresponding to the first video camera. This may be desirable if only video from the first camera is needed. The other

Accordingly, now referring to FIG. 29 for this simple example, note that the first code 942 (“1111”) is assigned and corresponds to the first location 902 of the output vector and it is this first code which is used to modulate the received levels 952-958 in order to produce the value of “0.3” in the first location 902 of the output vector. Thus, if only the data stream from the first video camera is desired, the receiver only decodes the incoming EM signals (e.g., levels 950) using the first code “1111”, thus producing the value and data stream shown at 902. In a similar fashion, if only the data stream for the third and fourth video cameras are desired, the receiver only decodes incoming levels 950 using the third and fourth codes, namely codes “1001” and “1010”. Therefore, the decoder of the receiver (whether SSVT or SSDT, or a combination of the two) may choose to decode only a single location of the output vector (i.e., a single data stream from the input vector of the transmitter) or may choose to decode two or more locations of the output vector (i.e., two more data streams input at the transmitter). In this fashion, even though any number or combination of video or data streams from any combination of video cameras, LiDAR, radar or ultrasonic sensors may be input to an SSVT or SSVT transmitter and transmitted over a single or multiple EM pathways, the receiver may selectively choose to only decode one or more of those data streams by choosing one or more of the codes 942 that correspond to each of the data streams desired. In other words, the incoming EM signal at the receiver (e.g. levels 950 of FIG. 29) includes all of the information of the data streams encoded at the transmitter, but the designer of the system may choose to decode only one or more of the data streams at the receiver by choosing whether to decode with only one or more of the codes or by using all of the codes. Each data stream may be decoded uniquely and independently of the other data streams by virtue of the orthogonal codes. The other data streams not chosen and their corresponding codes may be ignored, deleted, not decoded or not dealt with in similar manners, so that effort, time and computing resources are only spent upon the data stream or streams that the designer wishes to decode. Encoding and decoding may be performed upon digital samples as shown and described in FIG. 28 in addition to upon analog samples as described.

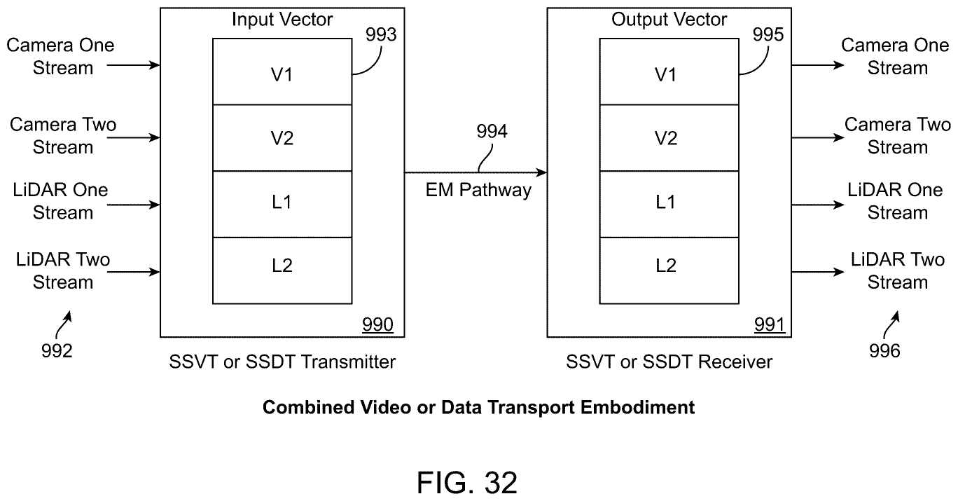

FIG. 32 illustrates one example of how the combined video data transport embodiment described in this section may be implemented. The transmitter 990 and the receiver 991 may be implemented according to any of the SSVT or SSVT transmitters or receivers described herein. This figure is a high-level view of the overall transport within a vehicle, showing relevant portions of FIGS. 3, 4, 28 and 30 (for example) in order to clearly described embodiments. Further details of this transport embodiment may be found in those figures and others within the specification

In this example, four data streams are presented to the transmitter, video streams from two different cameras and data streams from two different LiDAR sensors. As explained above, there may be any number of data streams (limited only by the value of N), and there may be any combination or permutation of data streams from video cameras, LiDAR sensors, radar sensors or ultrasonic sensors. The distributor of the transmitter continuously distributes samples from the input streams into input vector 993, distributing samples from camera one into the first location, V1, samples from camera two into the second location, V2, samples from LiDAR sensor one into the third location, L1, and samples from a lid LiDAR sensor two into the fourth location, L2. As mentioned, each video or data stream may occupy more than one location in the input vector. The input vector is encoded into output levels and those levels are sent over a single EM pathway 994 to a corresponding receiver. As mentioned, there may be more than one input vector into which the incoming data streams are distributed and each input vector is sent over its own EM pathway, for example as shown in FIG. 3. As described herein, receiver 991 decodes the incoming EM signal into output vector 991 and then outputs a stream for each of its locations, thus producing output 996 being a camera one video stream, a camera two video stream, a LiDAR one data stream and a LiDAR two data stream, all corresponding to the input streams 992.

As mentioned above, it may be desirable to decode and output only a single one of the video or data streams by only using the corresponding orthogonal code to decode a location of the output vector, thus producing the data stream corresponding to that location. More than one location and stream may be decoded and output by using more than one of the orthogonal codes, or all of the codes may be used thus producing all of the outputs 996.

### OTHER EMBODIMENTS

The invention includes these other embodiments.

C1. In a vehicle, a method of transporting video samples, said method comprising:
receiving over at least one electromagnetic pathway, at a receiver of an ADAS or IVI processor, analog levels representing analog video samples originating at an image sensor of a video camera mounted on said vehicle;
collecting said analog levels into an output vector of analog video samples per said at least one electromagnetic pathway;
converting said analog video samples into digital video samples; and
sending said digital video samples to said ADAS or IVI processor.

C2. A method as recited in claim C1 further comprising:
utilizing said digital video samples received at said ADAS processor to drive an actuator in order to control said vehicle.

C3. A method as recited in claim C1 further comprising:
performing color interpolation upon said digital video samples to produce RGB color samples; and
displaying said digital video samples received at said IVI processor on a display of said vehicle in order to display video captured at said video camera.

C4. A method as recited in claim C1 further comprising:
decoding each set of L analog levels using a set of N mutually-orthogonal spreading codes to produce said each output vector of N analog video samples, wherein L>=N>=2, and wherein each of said codes being used to produce one of said analog video samples.

C5. A method as recited in claim C1 further comprising:
collecting said analog levels into a plurality of line buffers holding said output vectors, said line buffers alternating outputting said output vectors to an analog-to-digital converter to produce said digital video samples.

D1. In a vehicle, a method of transporting video samples, said method comprising:
receiving over at least one electromagnetic pathway, at a receiver of an ADAS or IVI processor, analog levels representing analog video samples originating at an image sensor of a video camera mounted on said vehicle;
collecting said analog levels into an output vector of analog video samples per said at least one electromagnetic pathway;
sending said analog video samples to said ADAS or IVI processor.

D2. A method as recited in claim D1 further comprising:
utilizing said analog video samples received at said ADAS processor to drive an actuator in order to control said vehicle.

D3. A method as recited in claim D1 further comprising:
displaying said analog video samples received at said IVI processor on a display of said vehicle in order to display video captured at said video camera.

D4. A method as recited in claim D1 further comprising:
decoding each set of L analog levels using a set of N mutually-orthogonal spreading codes to produce said each output vector of N analog video samples, wherein L>=N>=2, and wherein each of said codes being used to produce one of said analog video samples.

D5. A method as recited in claim D1 further comprising:
collecting said analog levels into a plurality of line buffers holding said output vectors, said line buffers alternating outputting said output vectors.

F1. In a vehicle, a method of transporting video samples, said method comprising:
receiving over at least one electromagnetic pathway, at least one receiver integrated with one of a plurality of source drivers of a display panel, analog levels representing analog video samples originating at an image sensor of a video camera mounted on said vehicle, each electromagnetic pathway terminating at one of said receivers and each receiver being integrated with one of said source drivers;
decoding a set of L analog levels at each source driver using a set of N mutually-orthogonal spreading codes to collect an output vector of N analog video samples, wherein L>=N>=2, and wherein each of said codes being used to produce one of said analog video samples; and
at each source driver, displaying said output vectors of analog video samples on said display panel of said vehicle in order to display video captured at said video camera, wherein said source drivers not including any DACs for converting video samples.

FFF1. In a vehicle, a method of transporting video samples, said method comprising:
receiving over at least one electromagnetic pathway at a receiver of a display panel, analog levels representing analog video samples originating at an image sensor of a video camera mounted on said vehicle;
decoding a set of L analog levels of each electromagnetic pathway using a set of N mutually-orthogonal spreading codes to collect an output vector of N analog video samples, wherein L>=N>=2, and wherein each of said codes being used to produce one of said analog video samples; and
converting each output vector of N analog video samples into N digital video samples;
sending said vectors of digital video samples to DACs of said display panel to create analog video samples; and
at each source driver of said display, displaying said vectors of analog video samples on said display panel of said vehicle in order to display video captured at said video camera.

FF1. In a vehicle, a method of transporting video samples, said method comprising:
receiving over at least one electromagnetic pathway, at least one receiver integrated with one of a plurality of source drivers of a display panel, analog levels representing analog video samples originating at an image sensor of a video camera mounted on said vehicle, each electromagnetic pathway terminating at one of said receivers and each receiver being integrated with one of said source drivers;
for each receiver, collecting said analog video samples into a plurality of line buffers, said line buffers alternating outputting said analog video samples to column drivers of the source driver with which said each receiver is integrated; and
at each source driver, displaying said analog video samples on said display panel of said vehicle in order to display video captured at said video camera, wherein said source drivers not including any DACs for converting video samples.

FFFF1. In a vehicle, a method of transporting video samples, said method comprising:
receiving over at least one electromagnetic pathway at a receiver of a display panel, analog levels representing analog video samples originating at an image sensor of a video camera mounted on said vehicle;
converting said analog levels into digital video samples;
sending said digital video samples to DACs of said display panel to create analog video samples; and
at each source driver of said display, displaying said analog video samples on said display panel of said vehicle in order to display video captured at said video camera.

G1. In a vehicle, a method of transporting LiDAR data values, said method comprising:
receiving, at a transmitter, digital LiDAR data values originating at a LiDAR sensor mounted on said vehicle, said digital LiDAR data values including at least x, y, and z coordinate values for each point in a point cloud;
distributing said digital LiDAR data values into at least one electromagnetic pathway, each electromagnetic pathway receiving an input vector of said digital LiDAR data values;
converting said digital LiDAR data values to analog LiDAR data values; and
transmitting said analog LiDAR data values as analog levels over said at least one electromagnetic pathway to an ADAS processor of said vehicle.

G2. A method as recited in claim G1 further comprising:
utilizing said analog levels received at said ADAS processor to drive an actuator in order to control said vehicle.

G4. A method as recited in claim G1 further comprising:
encoding said each input vector of N analog LiDAR data values using a set of N mutually-orthogonal spreading codes to produce said L analog levels, wherein L>=N>=2, and wherein each of said codes being used to encode one of said analog LiDAR data values.

G5. A method as recited in claim G1 further comprising:
distributing said digital LiDAR data values into a plurality of line buffers holding said input vectors, said line buffers alternating outputting said input vectors to said respective electromagnetic pathways.

H1. In a vehicle, a method of transporting LiDAR data values, said method comprising:
receiving over at least one electromagnetic pathway, at a receiver of an ADAS processor, analog levels representing LiDAR data values originating at a LiDAR sensor mounted on said vehicle, said LiDAR data values including at least x, y, and z coordinate values for each point in a point cloud;
collecting said analog levels into an output vector of analog LiDAR data values per said at least one electromagnetic pathway;
converting said analog LiDAR data values into digital LiDAR data values; and
sending said digital LiDAR data values to said ADAS processor.

H2. A method as recited in claim H1 further comprising:
utilizing said digital LiDAR data values received at said ADAS processor to drive an actuator in order to control said vehicle.

H4. A method as recited in claim H1 further comprising:
decoding each set of L analog levels using a set of N mutually-orthogonal spreading codes to produce said each output vector of N analog LiDAR data values, wherein L>=N>=2, and wherein each of said codes being used to produce one of said analog LiDAR data values.

H5. A method as recited in claim H1 further comprising:
collecting said analog LiDAR data values into a plurality of line buffers holding said output vectors, said line buffers alternating outputting said output vectors to an analog-to-digital converter to produce said digital LiDAR data values.

I1. In a vehicle, a method of transporting radar data values, said method comprising:
receiving, at a transmitter, digital radar data values originating at a radar sensor mounted on said vehicle, said digital radar data values including distance measurement values of objects detected;
distributing said digital radar data values into at least one electromagnetic pathway, each electromagnetic pathway receiving an input vector of said digital radar data values;
converting said digital radar data values to analog radar data values; and
transmitting said analog radar data values as analog levels over said at least one electromagnetic pathway to an ADAS processor of said vehicle.

I2. A method as recited in claim I1 further comprising:
utilizing said analog levels received at said ADAS processor to drive an actuator in order to control said vehicle.

I4. A method as recited in claim I1 further comprising:
encoding said each input vector of N analog radar data values using a set of N mutually-orthogonal spreading codes to produce said L analog levels, wherein L>=N>=2, and wherein each of said codes being used to encode one of said analog radar data values.

I5. A method as recited in claim I1 further comprising:
distributing said digital radar data values into a plurality of line buffers holding said input vectors, said line buffers alternating outputting said input vectors to said respective electromagnetic pathways.

J1. In a vehicle, a method of transporting radar data values, said method comprising:
receiving over at least one electromagnetic pathway, at a receiver of an ADAS processor, analog levels representing radar data values originating at a radar sensor mounted on said vehicle, said radar data values including distance measurement values of objects detected;
collecting said analog levels into an output vector of analog radar data values per said at least one electromagnetic pathway;
converting said analog radar data values into digital radar data values; and
sending said digital radar data values to said ADAS processor.

J2. A method as recited in claim J1 further comprising:
utilizing said digital radar data values received at said ADAS processor to drive an actuator in order to control said vehicle.

J4. A method as recited in claim J1 further comprising:
decoding each set of L analog levels using a set of N mutually-orthogonal spreading codes to produce said each output vector of N analog radar data values, wherein L>=N>=2, and wherein each of said codes being used to produce one of said analog radar data values.

J5. A method as recited in claim J1 further comprising:
collecting said analog radar data values into a plurality of line buffers holding said output vectors, said line buffers alternating outputting said output vectors to an analog-to-digital converter to produce said digital radar data values.

K1. In a vehicle, a method of transporting ultrasonic data values, said method comprising:
receiving, at a transmitter, digital ultrasonic data values originating at an ultrasonic sensor mounted on said vehicle, said digital ultrasonic data values including distance measurement values of objects detected;
distributing said digital ultrasonic data values into at least one electromagnetic pathway, each electromagnetic pathway receiving an input vector of said digital ultrasonic data values;
converting said digital ultrasonic data values to analog ultrasonic data values; and
transmitting said analog ultrasonic data values as analog levels over said at least one electromagnetic pathway to an ADAS processor of said vehicle.

K2. A method as recited in claim K1 further comprising:
utilizing said analog levels received at said ADAS processor to drive an actuator in order to control said vehicle.

K4. A method as recited in claim K1 further comprising:
encoding said each input vector of N analog ultrasonic data values using a set of N mutually-orthogonal spreading codes to produce said L analog levels, wherein L>=N>=2, and wherein each of said codes being used to encode one of said analog ultrasonic data values.

K5. A method as recited in claim K1 further comprising:
distributing said digital ultrasonic data values into a plurality of line buffers holding said input vectors, said line buffers alternating outputting said input vectors to said respective electromagnetic pathways.

L1. In a vehicle, a method of transporting ultrasonic data values, said method comprising:
receiving over at least one electromagnetic pathway, at a receiver of an ADAS processor, analog levels representing radar data values originating at an ultrasonic sensor mounted on said vehicle, said ultrasonic data values including distance measurement values of objects detected;
collecting said analog levels into an output vector of analog ultrasonic data values per said at least one electromagnetic pathway;
converting said analog ultrasonic data values into digital ultrasonic data values; and
sending said digital ultrasonic data values to said ADAS processor.

L2. A method as recited in claim L1 further comprising:
utilizing said digital ultrasonic data values received at said ADAS processor to drive an actuator in order to control said vehicle.

L4. A method as recited in claim L1 further comprising:
decoding each set of L analog levels using a set of N mutually-orthogonal spreading codes to produce said each output vector of N analog ultrasonic data values, wherein L>=N>=2, and wherein each of said codes being used to produce one of said analog ultrasonic data values.

L5. A method as recited in claim L1 further comprising:
collecting said analog ultrasonic data values into a plurality of line buffers holding said output vectors, said line buffers alternating outputting said output vectors to an analog-to-digital converter to produce said digital ultrasonic data values.

M1. In a vehicle, a method of transporting samples, said method comprising:
receiving, at a transmitter, first digital video samples originating at an image sensor of a first video camera mounted on said vehicle and second digital video samples originating at an image sensor of a second video camera mounted on said vehicle;
distributing said first and second digital video samples into an input vector of said transmitter;
encoding said input vector of said first and second digital video samples using a set of mutually-orthogonal spreading codes to produce a plurality of output levels, wherein each of said codes being used to encode one of said digital video samples;
converting said output levels into analog output levels; and
transmitting said analog output levels over an electromagnetic pathway to an ADAS or IVI processor of said vehicle.

N1. In a vehicle, a method of transporting data values, said method comprising:
receiving, at a transmitter, first LiDAR data values originating at a first LiDAR sensor mounted on said vehicle and second LiDAR data values originating at a second LiDAR sensor mounted on said vehicle;
distributing said first and second LiDAR data values into an input vector of said transmitter;
encoding said input vector of said first and second LiDAR data values using a set of mutually-orthogonal spreading codes to produce a plurality of output levels, wherein each of said codes being used to encode one of said LiDAR data values.
converting said output levels into analog output levels; and
transmitting said analog output levels over an electromagnetic pathway to an ADAS processor of said vehicle.

O1. In a vehicle, a method of transporting data values, said method comprising:
receiving, at a transmitter, first radar data values originating at a first radar sensor mounted on said vehicle and second radar data values originating at a second radar sensor mounted on said vehicle;
distributing said first and second radar data values into an input vector of said transmitter;
encoding said input vector of said first and second radar data values using a set of mutually-orthogonal spreading codes to produce a plurality of output levels, wherein each of said codes being used to encode one of said radar data values;
converting said output levels into analog output levels; and
transmitting said analog output levels over an electromagnetic pathway to an ADAS processor of said vehicle.

R1. In a vehicle, a method of transporting video samples, said method comprising:
receiving over an electromagnetic pathway, at a receiver of an ADAS or IVI processor, analog levels representing first video samples originating at an image sensor of a first video camera mounted on said vehicle and representing second video samples originating at an image sensor of a second video camera mounted on said vehicle, wherein said analog levels being produced by encoding said first and second video samples using N mutually-orthogonal spreading codes;
decoding said analog levels using M of said mutually-orthogonal spreading codes into an output vector of M analog video samples, wherein M being less than N, and wherein said M analog video samples represent only said first video samples of said first video camera;
converting said M analog video samples into digital video samples; and
sending said digital video samples to said ADAS or IVI processor.

S1. In a vehicle, a method of transporting data values, said method comprising:
receiving over an electromagnetic pathway, at a receiver of an ADAS processor, analog levels representing first data values originating at a first LiDAR sensor mounted on said vehicle and representing second data values originating at a second LiDAR sensor mounted on said vehicle, wherein said analog levels being produced by encoding said first and second data values using N mutually-orthogonal spreading codes;
decoding said analog levels using M of said mutually-orthogonal spreading codes into an output vector of M analog data values, wherein M being less than N, and wherein said M analog data values represent only said first data values of said first LiDAR sensor;
converting said M analog data values into digital data values; and
sending said digital data values to said ADAS processor.

T1. In a vehicle, a method of transporting data values, said method comprising:
receiving over an electromagnetic pathway, at a receiver of an ADAS processor, analog levels representing first data values originating at a first radar sensor mounted on said vehicle and representing second data values originating at a second radar sensor mounted on said vehicle, wherein said analog levels being produced by encoding said first and second data values using N mutually-orthogonal spreading codes;
decoding said analog levels using M of said mutually-orthogonal spreading codes into an output vector of M analog data values, wherein M being less than N, and wherein said M analog data values represent only said first data values of said first radar sensor;
converting said M analog data values into digital data values; and
sending said digital data values to said ADAS processor.

### Computer System Embodiment

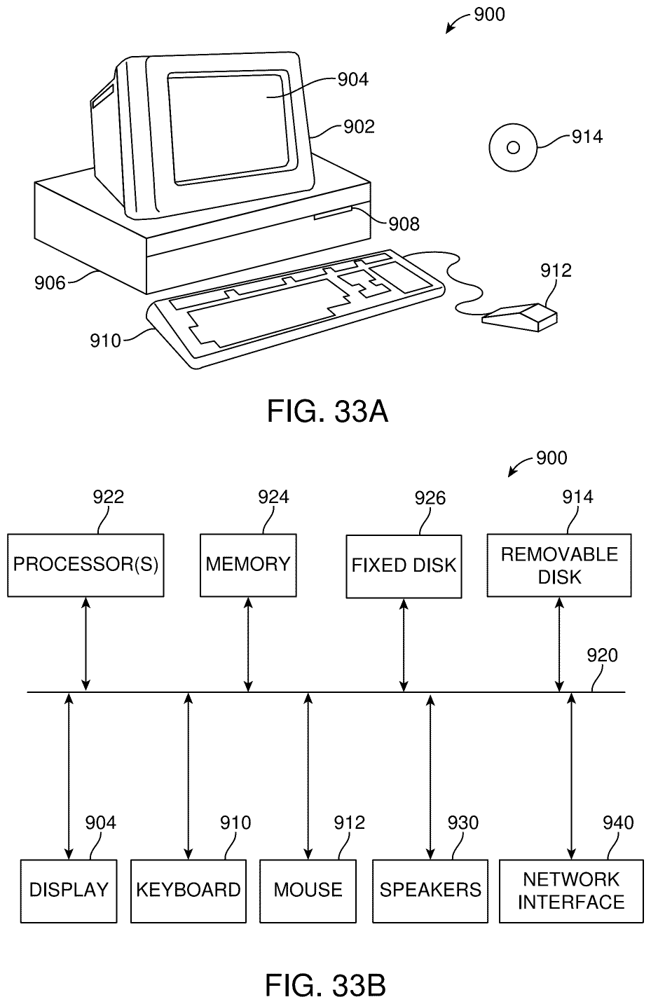

FIGS. 33A and 33B illustrate a computer system 900 suitable for implementing embodiments of the present invention. FIG. 33A shows one possible physical form of the computer system. Of course, the computer system may have many physical forms including an integrated circuit, a printed circuit board, a small handheld device (such as a mobile telephone or PDA), a personal computer or a super computer. Computer system 900 includes a monitor 902, a display 904, a housing 906, a disk drive 908, a keyboard 910 and a mouse 912. Disk 914 is a computer-readable medium used to transfer data to and from computer system 900.

FIG. 33B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary mass storage medium (such as a hard disk, a solid-state drive, a hybrid drive, flash memory, etc.) that can be slower than primary storage but persists data. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind that is well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

We claim:

1. In a vehicle, a method of transporting video samples, said method comprising:
receiving, at a transmitter, digital video samples originating at an image sensor of a video camera mounted on said vehicle;
distributing said digital video samples into at least one electromagnetic pathway, each electromagnetic pathway receiving an input vector of said digital video samples;
converting said digital video samples to analog video samples; and
transmitting said analog video samples as analog levels over said at least one electromagnetic pathway to an ADAS or IVI processor of said vehicle.

2. A method as recited in claim 1 further comprising:
utilizing said analog levels received at said ADAS processor to drive an actuator in order to control said vehicle.

3. A method as recited in claim 1 further comprising:
displaying said analog levels received at said IVI processor on a display of said vehicle in order to display video captured at said video camera.

4. A method as recited in claim 1 further comprising:
encoding said each input vector of N analog video samples using a set of N mutually-orthogonal spreading codes to produce said L analog levels, wherein L>=N>=2, and wherein each of said codes being used to encode one of said analog video samples.

5. A method as recited in claim 1 further comprising:
distributing said digital video samples into a plurality of line buffers holding said input vectors, said line buffers alternating outputting said input vectors to said respective electromagnetic pathways.

6. In a vehicle, a method of transporting video samples, said method comprising:
receiving, at a transmitter, analog video samples directly from an image sensor of a video camera mounted on said vehicle;
distributing said analog video samples into at least one electromagnetic pathway, each electromagnetic pathway receiving an input vector of said analog video samples; and
transmitting said analog video samples as analog levels over said at least one electromagnetic pathway to an ADAS or IVI processor of said vehicle.

7. A method as recited in claim 6 further comprising:
utilizing said analog levels received at said ADAS processor to drive an actuator in order to control said vehicle.

8. A method as recited in claim 6 further comprising:
displaying said analog levels received at said IVI processor on a display of said vehicle in order to display video captured at said video camera.

9. A method as recited in claim 6 further comprising:
encoding said each input vector of N analog video samples using a set of N mutually-orthogonal spreading codes to produce said L analog levels, wherein L>=N>=2, and wherein each of said codes being used to encode one of said analog video samples.

10. A method as recited in claim 6 further comprising:
distributing said analog video samples into a plurality of line buffers holding said input vectors, said line buffers alternating outputting said input vectors to said respective electromagnetic pathways.

11. In a vehicle, a method of transporting video samples, said method comprising:
receiving, at a transmitter from an IVI processor, digital video samples originating at an image sensor of a video camera mounted on said vehicle;
distributing said digital video samples into at least one electromagnetic pathway, each electromagnetic pathway receiving an input vector of said digital video samples;
converting said digital video samples to analog video samples; and
transmitting said analog video samples as analog levels over said at least one electromagnetic pathway, each of said at least one electromagnetic pathway terminating at one of a plurality of source drivers of a display panel of said vehicle.

12. A method as recited in claim 11 further comprising:
displaying said analog levels received at said source drivers on said display of said vehicle in order to display video captured at said video camera.

13. A method as recited in claim 11 further comprising:
encoding said each input vector of N analog video samples using a set of N mutually-orthogonal spreading codes to produce said L analog levels, wherein L>=N>=2, and wherein each of said codes being used to encode one of said analog video samples.

14. A method as recited in claim 11 further comprising:
distributing said digital video samples into a plurality of line buffers holding said input vectors, said line buffers alternating outputting said input vectors to said respective electromagnetic pathways.
